(19) United States
(12) Patent Application Publication
(10) Pub. No.: US 2014/0186215 A1
(43) Pub. Date: Jul. 3, 2014

(54) SENSOR ELEMENT, DEW CONDENSATION SENSOR, HUMIDITY SENSOR, METHOD FOR DETECTING DEW CONDENSATION, AND DEW-POINT MEASUREMENT DEVICE

(71) Applicants: Ryuzo Shinta, Chiba (JP); Yasufumi Matsumura, Chiba (JP); Yasushi Enomoto, Chiba (JP)

(72) Inventors: Ryuzo Shinta, Chiba (JP); Yasufumi Matsumura, Chiba (JP); Yasushi Enomoto, Chiba (JP)

(73) Assignee: NIPPON STEEL & SUMIKIN CHEMICAL CO., LTD., TOKYO (JP)

(21) Appl. No.: 14/125,311

(22) PCT Filed: May 30, 2012
(86) PCT No.: PCT/JP2012/063858

§ 371 Date: Dec. 10, 2013

(30) Foreign Application Priority Data
Jun. 13, 2011 (JP) 2011-131611

(51) Int. Cl. G01N 21/65; G01N 21/47; G01N 27/414

(52) U.S. Cl. CPC G01N 21/658; G01N 27/4146; G01N 21/47; Y10S 977/773; Y10S 977/92; B82Y 15/00
USPC 422/69; 250/574; 73/73; 977/773; 977/920

(57) ABSTRACT

A dew condensation sensor is described, including a nano-composite for generating local surface plasmon resonance, a light reflecting member disposed on one side of the nano-composite, a protection layer laminated on the light reflecting member, a light source/light receiver disposed facing the nano-composite, a spectroscope (or photo-detector) for detecting the light reflected by the light source/light receiver, a controller connected to the light source/light receiver and the spectroscope (or photo-detector) and used for overall control thereof, and a display unit connected to the controller. The dew condensation sensor detects occurrence of dew condensation based on the variation in the absorption spectrum, the absorption intensity or the reflected-light intensity of the local surface plasmon resonance of the nano-composite.

### TECHNICAL FIELD

The invention relates to a sensor element useful in various types of sensing, and a dew condensation sensor, a humidity sensor, a dew condensation detecting method and a dew point measurement device as application examples of the sensor element.

### BACKGROUND ART

Nano-sized fine-particles have a geometrically high specific surface area, and also exhibit changes in optical properties, lowering of melting point, high catalytic properties, high magnetic properties and so on due to quantum size effects. Hence, the fine-particles are expected to offer new functions which could not be achieved with bulk materials, such as improvement of catalytic reaction, luminescence properties and other chemical or physical conversion properties, and have been a very important material in various fields such as electronic material, catalyst material, phosphor material, luminous body material, medical supplies and so on. In particular, for metal fine-particles with a size of about several nm to 100 nm, there is a phenomenon called localized surface plasmon resonance (LSPR) in which electrons in the fine-particles interact and resonate with light of a specific wavelength. Recently, this phenomenon has been utilized, and its application to various devices has been studied. This localized surface plasmon resonance is sensitive to the variation in the dielectric constant ∈ₘ(λ) [=(nₘ(λ))²] (nₘ is the refractive index) of the medium surrounding the metal fine-particles, and thus have a characteristic that the resonance wavelength varies with the variation in the dielectric constant (or refractive index) of the medium surrounding the metal fine-particles. Based on this, applications of LSPR in the field of sensing have been actively discussed.

In addition, along with the advance of the electronic information society, a variety of electronic devices are utilized. In processes of manufacturing and utilizing the electronic devices, moisture that causes a short circuit in electronic components such as an electronic circuit has become a big problem, and thus there is demand to develop a method of sensing dew condensation in advance. An exemplary method to determine the temperature at which dew condensation occurs includes measuring a dew point temperature by means of a dew point meter. The dew point meter is roughly classified into electrostatic capacity-type dew point meter and cooling-type dew point meter. The electrostatic capacity-type dew point meter measures capacitance variation caused by adhesion of moisture using a high molecular compound or aluminum oxide so as to measure a dew point. In addition, the cooling-type dew point meter cools an observed surface and measures the temperature at the occurrence of dew condensation. However, since the electrostatic capacity-type dew point meter measures a dew point indirectly from a measurement result of the capacitance of the high molecular compound or aluminum oxide, it must have a problem that an error easily occurs in the dew point. In addition, although a mirror-cooling dew point meter obtains a more accurate dew point than the electrostatic capacity-type dew point meter, since the dew point temperature is measured once dew condensation occurs on a mirror surface, the mirror-cooling dew point meter can't sense occurrence of dew condensation in advance.

Meanwhile, Patent Document 1 discloses a dew condensation prediction device that predicts dew condensation beforehand. This invention includes a heat conducting element, a dew condensation sensor thermally coupled to this heat conducting element and a power supply providing an electric current to this heat conducting element, and predicts dew condensation while maintaining the dew condensation sensor at a temperature lower than an ambient temperature by means of the heat conducting element. By using this method, the dew condensation may be predicted beforehand since dew condensation occurs in advance on the dew condensation sensor that has been maintained at the temperature lower than the ambient temperature. However, as it is necessary to always maintain the dew condensation sensor at a temperature lower than the ambient temperature, a cooling device, a temperature control device, and electricity for keeping the above always in operation are required. In addition, Patent Document 2 discloses a method of predicting dew condensation, in which a sensing member of a surface on which dew condensation is to be predicted is connected to a heating means and a cooling means, and the surface is heated by the heating means by a temperature ΔT from the initial temperature of the surface and then cooled by a temperature 2ΔT. The dew condensation is predicted by the ratio of the time required for ΔT to that for 2ΔT. However, in this method, in order to predict dew condensation, it is necessary to compare the time ratio. Accordingly, a certain period of time is required for predicting dew condensation, such that there was a problem that the occurrence of dew condensation cannot be predicted immediately.

As mentioned above, the prior art for predicting dew condensation required a mechanism for always maintaining the dew condensation sensor at a temperature lower than the ambient temperature, and had a problem that the detection of dew condensation takes time. Hence, a technique capable of detecting or predicting dew condensation by a more simple method in a short time and with good precision has been in demand.

In addition to the dew condensation sensor, provision of a technique capable of performing detection of, e.g., humidity variation, chemical substances, biomolecules and so on more simply in a short time with good precision has been in demand.

### PRIOR-ART DOCUMENTS

### Patent Documents

Patent Document 1: Japan Patent Application Publication No. 1989-127942
Patent Document 2: Japan Patent Application Publication No. 1994-300721

### SUMMARY OF THE INVENTION

### Problems to be Solved by the Invention

An object of the invention is to provide a sensor element capable of performing various detection rapidly in a high sensitivity with a simple device configuration.

### Means for Solving the Problems

In view of the foregoing, the present inventors have conducted intensive studies and consequently found that a sensor element with highly-sensitive responsiveness to a detected substance may be fabricated by utilizing a metal fine-particle dispersed composite material that includes metal fine-particles dispersed three-dimensionally in a matrix having a 3D network structure, thus completing the invention.

That is to say, a sensor element of the first aspect of the invention includes a metal fine-particle dispersed composite, and a detection unit detecting variation in the optical signal or electrical signal generated by interaction between a detected substance and the metal fine-particle dispersed composite. This sensor element is characterized in that the metal fine-particle dispersed composite therein includes a matrix layer including a solid framework and voids formed by the solid framework, and metal fine-particles immobilized to the solid framework.

In the sensor element of the first aspect of the invention, the metal fine-particle dispersed composite may have the following constitutions a) to d):

a) the solid framework containing an aluminum oxyhydroxide or an alumina hydrate and forming a 3D network structure;
b) the metal fine-particles having a mean particle diameter in the range of 3 to 100 nm, with a proportion of 60% or more having particle diameters in the range of 1 to 100 nm;
c) the metal fine-particles being present in a manner that they are not in contact with one another and neighboring metal fine-particles are apart from each other by a distance equal to or larger than the particle diameter of the larger one of the neighboring metal fine-particles; and
d) the metal fine-particles are dispersed three-dimensionally in the matrix layer, wherein each metal fine-particle has a portion exposed in the voids of the matrix layer.

In the sensor element of the first aspect of the invention, the metal fine-particle dispersed composite of the invention may have a void ratio in the range of 15% to 95%.

In the sensor element of the first aspect of the invention, the volume fraction of the metal fine-particles in the metal fine-particle dispersed composite may be in the range of 0.05 to 30%.

In the sensor element of the first aspect of the invention, the metal fine-particles may include Au, Ag or Cu.

In the sensor element of the first aspect of the invention, the metal fine-particles may induce LSPR when interacting with light of a wavelength of 380 nm or more.

A dew condensation sensor of the second aspect of the invention includes a metal fine-particle dispersed composite, a light reflecting member disposed on one side of the metal fine-particle dispersed composite, a light source irradiating the metal fine-particle dispersed composite with light, a light receiver receiving light reflected by a surface of the metal fine-particle dispersed composite and the light reflecting member, and a spectroscopic device measuring the absorption spectrum of the reflected light or a photo-detector measuring the intensity of the reflected light. This dew condensation sensor is characterized in that the metal fine-particle dispersed composite therein includes a matrix layer including a solid framework and voids formed by the solid framework, and metal fine-particles immobilized to the solid framework.

In the dew condensation sensor of the second aspect of the invention, the metal fine-particle dispersed composite may include a first surface receiving light emitted from the light source, and a second surface formed opposite to the first surface. The light reflecting member may be disposed in contact with the second surface.

In the dew condensation sensor of the second aspect of the invention, the light reflective member may include a light transmitting layer, and a metal layer laminated on the light transmitting layer.

In the dew condensation sensor of the second aspect of the invention, the light reflecting member may further include a protection layer covering the metal layer.

In the dew condensation sensor of the second aspect of the invention, the protection layer may include a Ni—Cr alloy.

A dew point measurement device of the third aspect of the invention includes the dew condensation sensor described in any of the above items, a temperature measurement device measuring the temperature of the metal fine-particle dispersed composite, and a temperature control device performing a temperature adjustment of the metal fine-particle dispersed composite.

A dew condensation detecting method of the fourth aspect of the invention detects occurrence of dew condensation based on variation in the absorption spectrum, the absorption intensity or the reflected-light intensity of LSPR, by means of the dew condensation sensor described in any of the above items.

A sensor element of the fifth aspect of the invention includes a light source emitting light, a light receiver receiving light, and a metal fine-particle dispersed composite interposed in the optical path between the light source and the light receiver. This sensor element is characterized in that the metal fine-particle dispersed composite therein includes a matrix layer including a solid framework and voids formed by the solid framework, and metal fine-particles immobilized to the solid framework.

A sensor element of the sixth aspect of the invention includes a light source emitting light, a light receiver receiving light, a light transmitting member forming an optical path between the light source and the light receiver, and a metal fine-particle dispersed composite disposed in proximity to the light transmitting member. This sensor element is characterized in that the metal fine-particle dispersed composite includes a matrix layer including a solid framework and voids formed by the solid framework, and metal fine-particles immobilized to the solid framework.

A humidity sensor of the seventh aspect of the invention includes the sensor element of the above fifth or sixth aspect to detect variation in humidity.

In the humidity sensor of the seventh aspect of the invention, the light source may irradiate the metal fine-particle dispersed composite with light of at least two kinds of wavelengths including a wavelength for humidity measurement and a wavelength for correction.

A field effect transistor sensor element of the eighth aspect of the invention includes a substrate, a source region and a drain region having a polarity opposite to the polarity of the substrate, a gate laminated body formed on the substrate between the source region and the drain region, and a metal fine-particle dispersed composite disposed on the gate laminated body. This field effect transistor sensor element is characterized in that the metal fine-particle dispersed composite therein includes a matrix layer including a solid framework and voids formed by the solid framework, and metal fine-particles immobilized to the solid framework.

### Effects of the Invention

With the sensor element of the invention, various sensing may be performed more simply in a short time with good precision, due to the use of the metal fine-particle dispersed composite that includes a matrix having a 3D network structure including a solid framework and voids defined by the solid framework, and metal fine-particles dispersed three-dimensionally in this matrix.

### BRIEF DESCRIPTION OF THE DRAWINGS

FIG. 1 schematically illustrates a structure of a matrix in a nano-composite that may be used in a dew condensation sensor according to the first embodiment of the invention.

FIG. 2 schematically illustrates a dispersion state of metal fine-particles in a cross section in the thickness direction of the nano-composite.

FIG. 3 schematically illustrates the dispersion state of metal fine-particles in a cross section parallel to the surface of the nano-composite in FIG. 2.

FIG. 4 illustrates a structure of metal fine-particles.

FIG. 5 illustrates a schematic configuration of a dew condensation sensor according to an embodiment of the invention.

FIG. 6 illustrates a method of determining dew condensation.

FIG. 7 illustrates a schematic configuration of a dew point meter that applied a dew condensation sensor.

FIG. 8 is a chart showing an example of a dew point evaluation method in Example 1.

FIG. 9 is a chart showing another example of the dew point evaluation method in Example 1.

FIG. 10 illustrates a schematic configuration of a humidity sensor according to the second embodiment of the invention.

FIG. 11 shows an example of an appearance configuration of the humidity sensor according to the second embodiment of the invention.

FIG. 12 is a side view showing a schematic configuration of a humidity sensor according to the first variant example.

FIG. 13 is a plan view showing a schematic configuration of the humidity sensor according to the first variant example.

FIG. 14 illustrates a schematic configuration of a humidity sensor according to the second variant example.

FIG. 15 illustrates a schematic constitution of a sensor element according to the third embodiment of the invention.

FIG. 16 schematically illustrates a structure example of a humidity sensor that used the sensor element according to the third embodiment of the invention.

FIG. 17 illustrates a schematic constitution of a sensor element according to the fourth embodiment of the invention.

FIG. 18 is a process chart illustrating a fabrication method of the sensor element according to the fourth embodiment.

FIG. 19 is a process chart that follows FIG. 18 to illustrate the fabrication method of the sensor element according to the fourth embodiment.

FIG. 20 illustrates, in a magnified view, a nano-composite with a binding species.

FIG. 21 illustrates a specific binding by means of a binding species.

### DESCRIPTION OF THE EMBODIMENTS

Embodiments of the invention are hereinafter described in details with reference to appropriate drawings. The sensor element of the invention includes a metal fine-particle dispersed composite, and a detection unit detecting variation in the optical signal or electrical signal generated by interaction between a detected substance and the metal fine-particle dispersed composite. Moreover, the metal fine-particle dispersed composite includes a matrix layer including a solid framework and voids formed by the solid framework, and metal fine-particles immobilized to the solid framework. The sensor element having such feature is adapted to various sensing devices such as dew condensation sensors, humidity sensors, gas sensors, bio-sensors, chemical sensors, SERS (surface-enhanced Raman scattering), SEIRA (surface enhanced infrared absorption spectroscopy), NSOM (near-field scanning optical microscope) and so on, and is capable of performing high-precision detection with a simple constitution. Next, preferred embodiments of the sensor element of the invention are described.

[Nano-Composite]

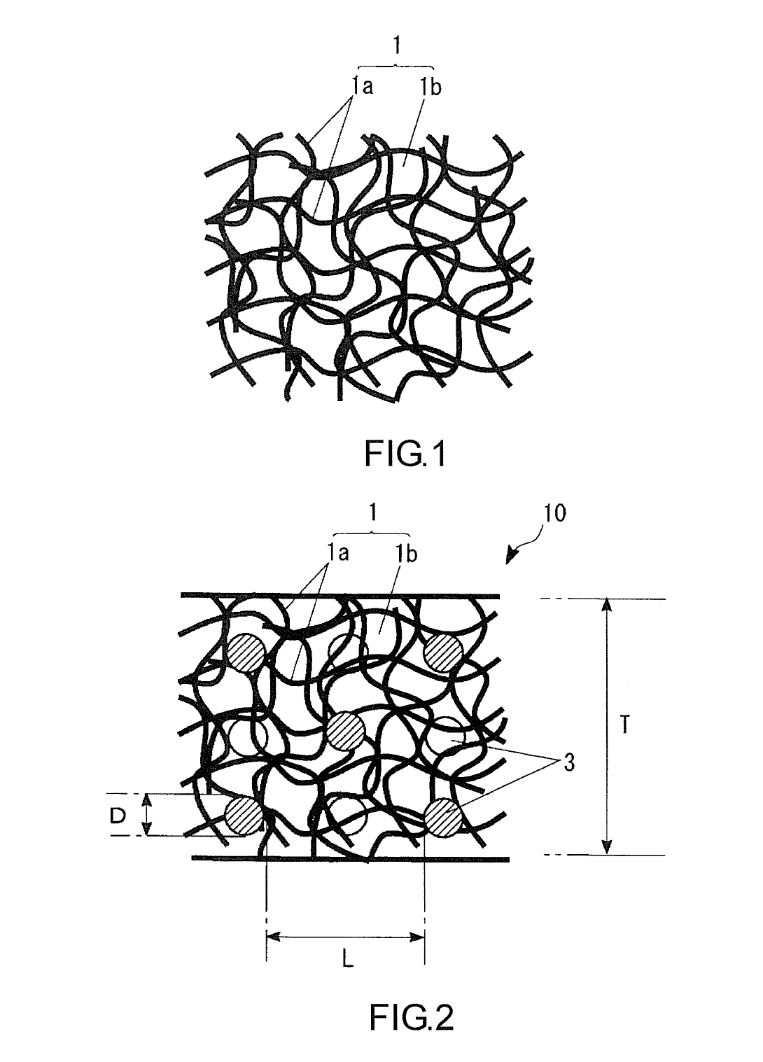

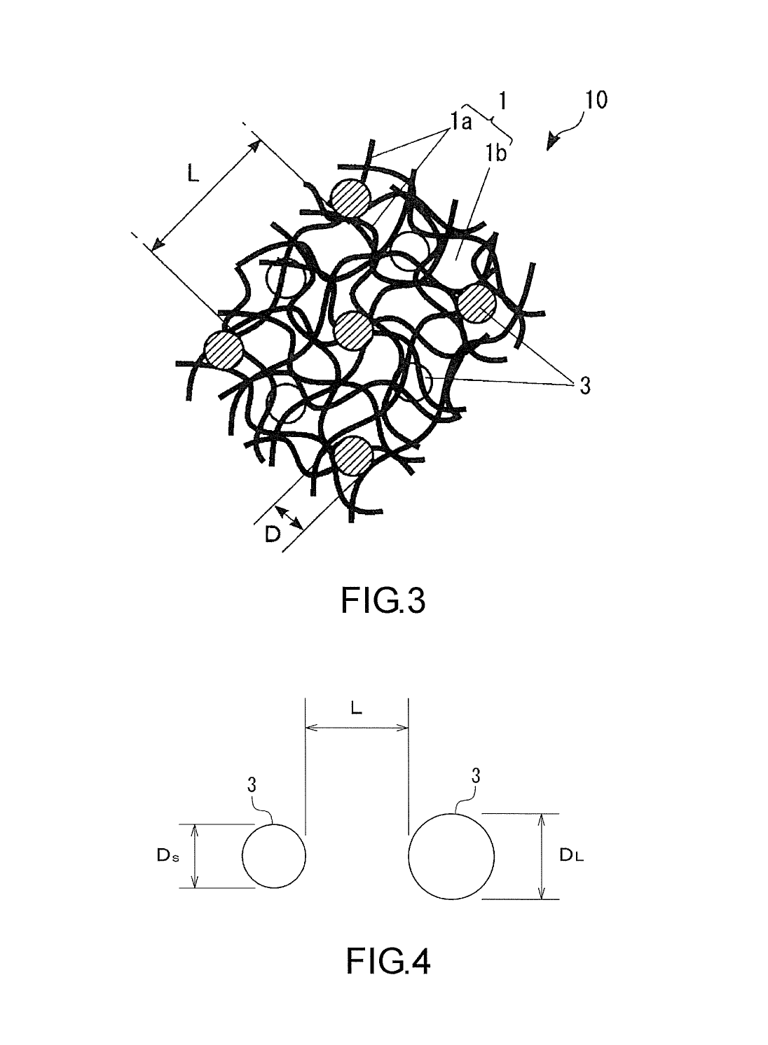

Firstly, the constitution of a nano-composite (metal fine-particle dispersed composite) used in the sensor element of the invention is described in detail with reference to FIGS. 1 to 4. FIG. 1 schematically illustrates a structure of a matrix layer 1 in a nano-composite 10. FIG. 2 schematically illustrates a dispersion state of metal fine-particles 3 in a cross section in a thickness direction of the nano-composite 10. FIG. 3 schematically illustrates the dispersion state of the metal fine-particles 3 in a cross section in a surface direction of the nano-composite 10. FIG. 4 illustrates the metal fine-particles 3 in a magnified view. Moreover, although it is shown in FIG. 4 that a particle diameter of a larger one of neighboring metal fine-particles 3 is denoted as D_{L} while that of a smaller one as D_{S}, in a case that no distinction is made between the two, a particle diameter is just denoted as D.

The nano-composite 10 used in the invention is a metal fine-particle dispersed composite that induces LSPR. In a case that a metal fine-particle dispersed composite including metal fine-particles dispersed in a matrix is applied to devices utilizing LSPR of metal fine-particles and so on, it is necessary to stabilize the metal fine-particles by immobilizing them to the matrix. It is important at least that the absorption spectrum thereof has a large intensity. In addition, generally, the sharper the absorption spectrum, the more possible it is to perform high-sensitivity detection. To achieve a sharp absorption spectrum with a large intensity, the metal fine-particle dispersed composite preferably has structural characteristics such as:

1) the size of the metal fine-particles being controlled within a predetermined range;

2) the shape of the metal fine-particles being uniform;

3) neighboring metal fine-particles being separated from each other while maintaining an inter-particle spacing equal to or larger than a certain value;

4) the volume filling ratio of the metal fine-particles relative to the metal fine-particle dispersed composite being controlled within a certain range; and

5) the metal fine-particles being present from a surface portion of the matrix, and also being distributed uniformly in the thickness direction of the same while maintaining a predetermined inter-particle distance.

In addition, to be applicable for sensors that highly sensitively detect the wavelength variation of LSPR caused by the variation in the environment outside the metal fine-particles, the metal fine-particle dispersed composite further preferably has, in addition to the above characteristics, the following structural characteristic:

6) the metal fine-particles being exposed to the outside environment.

The nano-composite 10 includes a matrix layer 1 including a solid framework 1a and voids 1b defined by the solid framework 1a, and the metal fine-particles 3 immobilized to the solid framework 1a of the matrix layer 1. In addition, the nano-composite 10 preferably has the following constitutions a) to d):

a) the solid framework 1a containing an aluminum oxyhydroxide or an alumina hydrate and forming a 3D network structure;

b) the metal fine-particles 3 having a mean particle diameter in the range of 3 to 100 nm, with a proportion of 60% or more having particle diameters D in the range of 1 to 100 nm;

c) the metal fine-particles 3 being present in a manner that they are not in contact with one another and neighboring metal fine-particles 3 are apart from each other by a distance equal to or larger than the particle diameter D_{L} of the larger one of the neighboring metal fine-particles; and

d) the metal fine-particles 3 being 3D-dispersed in the matrix layer 1, wherein each metal fine-particle 3 has a portion exposed in the voids 1b of the matrix layer 1.

(Matrix Layer)

As shown in FIG. 1, the matrix layer 1 includes the solid framework 1a and the voids 1b defined by the solid framework 1a. The voids 1b communicate with an external space of the matrix layer 1. As described in the above point a), the solid framework 1a preferably includes an aluminum oxyhydroxide or an alumina hydrate and forms a 3D network structure. In this case, the solid framework 1a is an aggregate of fine inorganic filler (or crystals) of a metal oxide containing an aluminum oxyhydroxide or an alumina hydrate, and the inorganic filler is in a shape of particle, scale, plate, needle, fiber, or cubic, etc. A 3D network structure including an aggregate of such inorganic filler is preferably obtained with a heating treatment to a slurry obtained by dispersing the inorganic filler of the metal oxide containing an aluminum oxyhydroxide or an alumina hydrate in a solution. In addition, the metal oxide containing an aluminum oxyhydroxide or an alumina hydrate is advantageous as a material having thermal resistance even at heat-reduction of metal ions forming the metal fine-particles 3, and is also preferred from in view of chemical stability. Further, although various materials such as boehmite (including pseudo-boehmite), gibbsite, diaspore and so on are known as an aluminum oxyhydroxide (or alumina hydrate), boehmite is especially preferred among them. Details of boehmite are described later.

A structural characteristic of such matrix layer 1 is that the matrix layer 1 has permeability to gas and liquid, thus becoming a cause of enhancement of the utilization efficiency of the metal fine-particles 3. In view of efficiently utilizing the high specific surface area and high activity of the metal fine-particles 3, the void ratio of the nano-composite 10 is preferably in the range of 15 to 95%. Here, the void ratio of the nano-composite 10 may be calculated using the apparent density (gross density) calculated from the area, thickness and weight of the nano-composite 10, and the density excluding the voids (true density) calculated from the inherent densities and the composition ratio of the materials forming the solid framework 1a of the matrix layer 1 and the metal fine-particles 3 according to the later-described Eq. (A). When the void ratio is less than 15%, the openness to the outside environment is lowered, so there are cases where the utilization efficiency of the metal fine-particles 3 is decreased. In addition, during fabrication of the nano-composite 10, in a case of impregnating a preformed matrix layer 1 with a solution containing a metal ion as a raw material of the metal fine-particles 3, for example, it becomes difficult to impregnate the whole matrix layer 1 so that it is hard to achieve an even dispersion state. Meanwhile, when the void ratio exceeds 95%, the presence proportions of the solid framework 1a and the metal fine-particles 3 are lowered, so there are cases where the mechanical strength drops and the effects (such as the LSPR effect) created by the metal fine-particles 3 are decreased.

In addition, as mentioned above, in view of efficiently utilizing the high specific surface area and high activity of the metal fine-particles 3, the volume proportion of the metal fine-particles 3 in the nano-composite 10 relative to the total volume of the voids 1b in the nano-composite 10 is preferably in the range of 0.08 to 50%.

The thickness T of the matrix layer 1 varies with the particle diameter D of the metal fine-particles 3, but, in applications utilizing LSPR, is preferably in the range of, e.g., 20 nm to 20 μm, and more preferably in the range of 30 nm to 10 μm.

In the case where the nano-composite 10 is applied to the uses that utilize LSPR, it is possible to utilize any of light-reflection or light-transmission LSPR. However, in the case where light-transmission LSPR is utilized, the matrix layer 1 preferably has light transmission properties for inducing LSPR of the metal fine-particles 3, and is particularly preferably a material transmitting light of a wavelength of 380 nm or more.

The solid framework 1a preferably includes an aluminum oxyhydroxide or an alumina hydrate easily forming a 3D network structure. Further, the solid framework 1a may also include, e.g., silicon oxide (silica), aluminum oxide (alumina), titanium oxide, vanadium oxide, tantalum oxide, iron oxide, magnesium oxide, or zirconium oxide, etc., or an inorganic oxide that contains plural kinds of metal elements. These may be included alone or in a combination of two or more.

(Metal Fine-Particles)

In the nano-composite 10 used in the invention, in view of easy control over an inter-particle distance L and the particle diameter D of the metal fine-particles 3, the metal fine-particles 3 are preferably obtained by heat-reducing a metal ion as a precursor thereof. The metal fine-particles 3 obtained in this way may include a metal species such as gold (Au), silver (Ag), copper (Cu), cobalt (Co), nickel (Ni), palladium (Pd), platinum (Pt), tin (Sn), rhodium (Rh) or iridium (Ir), etc. In addition, an alloy (such as a Pt—Co alloy, etc.) of these metal species may be included. Among them, Au, Ag, Cu, Pd, Pt, Sn, Rh and Ir may be taken as examples particularly suitable for use as metal species inducing LSPR. As metal species inducing LSPR by interacting with light in a visible region having a wavelength of 380 nm or more, Au, Ag and Cu are preferred. Especially, Au is most expected since it is hardly surface oxidized and is good in preservation stability.

The metal fine-particles 3 may be in various shapes, such as sphere, prolate spheroid, cube, truncated tetrahedron, bipyramid, regular octahedron, regular decahedron, regular icosahedron and so on. Nevertheless, a sphere shape in which the LSPR absorption spectrum is sharp is most preferred. Here, the shape of the metal fine-particles 3 may be identified by observing with a transmission electron microscope (TEM). In addition, the mean particle diameter of the metal fine-particles 3 is defined as an area-average diameter of arbitrary 100 metal fine-particles 3 being measured. In addition, the so-called spherical metal fine-particles 3 are metal fine-particles in a shape of a sphere or a near-sphere that has a ratio of the average long diameter to the average short diameter being 1 or close to 1 (preferably 0.8 or more). Further, regarding the relationship between the long diameter and the short diameter of any individual metal fine-particle 3, it is preferred that the long diameter is less than 1.35 times the short diameter, and is more preferred that the long diameter is equal to or less than 1.25 times the short diameter. Further, when the metal fine-particles 3 do not have a spherical shape but have, e.g., a regular octahedral shape, the largest one among edge lengths of the metal fine-particles 3 is taken as the long diameter of the same, the smallest one among the edge lengths is taken as the short diameter of the same, and the above long diameter is considered as the particle diameter D of the same.

As shown in the above b), it is preferred that the metal fine-particles 3 have a mean particle diameter in the range of 3 to 100 nm, with a proportion of 60% or more having particle diameters D in the range of 1 to 100 nm. Here, the mean particle diameter means the average value of the diameter (median diameter) of the metal fine-particles 3. When the proportion (number proportion relative to all the metal fine-particles) of the metal fine-particles 3 having the particle diameters D in the range of 1 to 100 nm is less than 60%, a high efficacy of LSPR is difficult to achieve. In addition, when the particle diameter D of the metal fine-particles 3 exceeds 100 nm, sufficient LSPR effect is difficult to make. Also, for example, for a nano-composite 10 including metal fine-particles 3 having a maximum particle diameter of about 50 to 75 nm or less, because the particle diameter distribution thereof is relatively small, it is easy to achieve a sharp LSPR absorption spectrum. Accordingly, the nano-composite 10 including metal fine-particles 3 having a maximum particle diameter of about 50 to 75 nm or less may be a preferred embodiment even if the particle diameter distribution of the metal fine-particles 3 is not particularly limited. On the other hand, even if the nano-composite 10 includes metal fine-particles 3 having a particle diameter exceeding 75 nm, the LSPR absorption spectrum becomes a sharp peak by decreasing the particle diameter distribution of the metal fine-particles 3. Accordingly, in this case, although the particle diameter distribution of the metal fine-particles 3 is also preferably controlled to be small, it is not particularly limited. In addition, because of the feature that the metal fine-particles 3 are dispersed with the inter-particle distance L equal to or larger than the particle diameter D, for example, magnetic metal fine-particles may be used as the metal fine-particles 3 to serve as magnetic bodies with excellent properties.

In a case where the metal fine-particles 3 are not spherical, the LSPR absorption spectrum tends to become broader since the apparent diameter becomes larger. Thus the particle diameter D in the case where the metal fine-particles 3 are not spherical is preferably 30 nm or less, more preferably 20 nm or less, and further preferably 10 nm or less. In addition, in the case where the metal fine-particles 3 are not spherical, it is preferred that the shapes of 80% or more, and more preferably, 90% or more of all of them in the matrix layer 1 are substantially the same, especially in a relative manner.

Metal fine-particles 3 having particle diameters D of less than 1 nm may be present in the nano-composite 10, which are not likely to affect LSPR and cause no particular problem. Further, relative to 100 weight parts of the total amount of the metal fine-particles 3 in the nano-composite 10, for example, in a case where the metal fine-particles 3 include gold, the amount of the particles 3 having particle diameters D of less than 1 nm is preferably set to be equal to or less than 10 weight parts, and more preferably equal to or less than 1 weight part. Here, the metal fine-particles 3 having particle diameters D of less than 1 nm may be detected by an XPS (X-ray photoelectron spectroscopy) analyzer or an EDX (energy dispersive X-ray) analyzer.

In addition, in order to achieve an LSPR effect with higher absorption spectrum intensity, the mean particle diameter of the metal fine-particles 3 is set to be at least 3 nm or more, preferably 10 nm or more and 100 nm or less, and more preferably 20 to 100 nm. In a case where the mean particle diameter of the metal fine-particles 3 is less than 3 nm, the intensity of the LSPR absorption spectrum tends to become small.

In the nano-composite 10, it is further preferred that the metal fine-particles 3 induce LSPR when interacting with light. The wavelength range for inducing LSPR varies with the particle diameter D, the particle shape, the metal species and the inter-particle distance L of the metal fine-particles 3, the refractive index of the matrix layer 1, and so on. Nevertheless, it is preferred to induce LSPR by light of a wavelength of, e.g., 380 nm or more.

(State of Presence of Metal Fine-Particles)

As shown in the above c), in the matrix layer 1, the metal fine-particles 3 are present in a manner that they are not in contact with one another, and neighboring metal fine-particles 3 are apart from each other by a distance equal to or larger than the particle diameter D_{L} of the larger one of the neighboring metal fine-particles 3. In other words, the spacing L (inter-particle distance) between the neighboring metal fine-particles 3 is equal to or larger than the particle diameter D_{L} of the larger one of the neighboring metal fine-particles 3 (L≧D_{L}). In FIG. 4, the inter-particle distance L of the metal fine-particles 3 is equal to or larger than the particle diameter D_{L} of the larger metal fine-particle 3. Accordingly, the metal fine-particles 3 are capable of efficiently exhibiting their LSPR properties. In the nano-composite 10 used in the invention, by heat-reducing the metal ion as a precursor of the metal fine-particles 3, thermal diffusion of the precipitated metal fine-particles 3 is easy, and the metal fine-particles 3 are dispersed in the matrix layer 1 with the inter-particle distance L equal to or greater than the particle diameter D_{L} of the larger one of the neighboring metal fine-particles 3. In a case where the inter-particle distance L is smaller than the particle diameter D_{L} of the larger one, interference between particles occurs at the LSPR. For example, there are cases where two neighboring particles work together like a large particle to induce LSPR, so a sharp absorption spectrum cannot be made. Meanwhile, although there is no particular problem if the inter-particle distance L is large, since the inter-particle distance L of the metal fine-particles 3 in the dispersed state caused by thermal diffusion closely relates to the particle diameter D of the metal fine-particles 3 and the later-described volume fraction of the metal fine-particles 3, the upper limit for the inter-particle distance L is preferably controlled with the lower limit of the volume fraction of the metal fine-particles 3. When the inter-particle distance L is large, in other words, when the volume fraction of the metal fine-particles 3 relative to the nano-composite 10 is small, the intensity of the LSPR absorption spectrum becomes small. In such case, by increasing the thickness of the nano-composite 10, the intensity of the LSPR absorption spectrum may be increased.

In addition, the metal fine-particles 3 are 3D-dispersed in the matrix layer 1. That is, when a cross section in the thickness direction of the matrix layer 1 with a 3D network structure in the nano-composite 10 and a cross section in a direction orthogonal to the thickness direction, i.e., a cross section parallel to a surface of the matrix layer 1, are observed, as shown in FIGS. 2 and 3, a large number of metal fine-particles 3 are dottedly distributed in the vertical direction and the horizontal direction with the inter-particle distance L equal to or greater than the particle diameter D_{L}.

Further, it is preferred that 90% or more of the metal fine-particles 3 are single particles dottedly distributed with the inter-particle distance L equal to or greater than the particle diameter D_{L}. “Single particle” herein means that each metal fine-particle 3 in the matrix layer 1 is present independently, and no aggregate of plural particles (aggregated particle) is included. That is, the single particles include no aggregated particle in which plural metal fine-particles aggregate by an inter-molecular force. In addition, “aggregated particle” refers to, for example, an aggregate formed by plural individual metal fine-particles gathering together, which is clearly confirmed by observation with a transmission electron microscope (TEM). Furthermore, although it is understood that the metal fine-particles 3 in the nano-composite 10 are, in terms of their chemical structure, metal fine-particles formed by aggregated metal atoms that are formed by heat-reduction, such metal fine-particles are considered to be formed through metal bonds between metal atoms and are distinguished from the aggregated particles formed by aggregation of plural particles. For example, when being observed with a TEM, an independent metal fine-particle 3 may be identified.

When 90% or more of the metal fine-particles 3 are single particles as described above, the LSPR absorption spectrum is sharp and stable, thus achieving high detection precision. This situation means that, in other words, aggregated particles or particles dispersed with the inter-particle distance L equal to or less than the particle diameter D_{L} account for less than 10%. In a case where such particles are present at 10% or more, the LSPR absorption spectrum gets broad or unstable, and high detection precision is difficult to achieve when the nano-composite 10 is used in a device such as a sensor. In addition, when aggregated particles or the particles dispersed with the inter-particle distance L equal to or less than the particle diameter D_{L} account for more than 10%, control of the particle diameter D also becomes extremely difficult.

In addition, the volume fraction of metal fine-particles 3 in the nano-composite 10 is preferably 0.05 to 30% relative to the nano-composite 10. The “volume fraction” is the percentage of the total volume of the metal fine-particles 3 in a certain volume of the nano-composite 10 (including voids 1b). When the volume fraction of the metal fine-particles 3 is less than 0.05%, the intensity of the LSPR absorption spectrum gets considerably small. Even if the thickness of the nano-composite 10 is increased, the effects are difficult to achieve. Meanwhile, when the volume fraction exceeds 30%, because the spacing (inter-particle distance L) between neighboring metal fine-particles 3 gets smaller than the particle diameter D_{L} of the larger one of the neighboring metal fine-particles 3, a sharp peak of the LSPR absorption spectrum is difficult to achieve.

In the nano-composite 10 used in the invention, as shown in the above point d), the metal fine-particles 3 are 3D-dispersed in the matrix layer 1, wherein each metal fine-particle 3 has a portion exposed in the voids 1b of the matrix layer 1. That is, in the nano-composite 10, since the metal fine-particles 3 are 3D-arranged in an efficient way with a high specific surface area, the utilization efficiency of the metal fine-particles 3 may be enhanced. In addition, as each metal fine-particle 3 has a portion exposed in the voids 1b that communicate with the outside environment, the metal fine-particles 3 are also sensitive to the variation in the dielectric constant ∈ₘ(λ) [=(nₘ(λ))²] (nₘ is the refractive index thereof) of the medium surrounding the metal fine-particles 3 and are capable of developing this characteristic. That is, the metal fine-particles 3 are capable of making the most of the characteristic that the resonance wavelength varies with the variation in the dielectric constant (or refractive index) of the medium surrounding the metal fine-particles 3. A structural feature of such nano-composite 10 is that the nano-composite 10 is most suitable for use in dew condensation sensors, humidity sensors, and so on among the applications utilizing LSPR.

In the nano-composite 10, when a cross section of the matrix layer 1 is observed using, e.g., a TEM or the like, through a transmitting electron beam, it is seen that the metal fine-particles 3 in the matrix layer 1 overlap with one another. However, as a matter of fact, the metal fine-particles 3 are dispersed as entirely independent single particles while maintaining therebetween a distance equal to or greater than a certain value. In addition, as being physically or chemically immobilized by the solid framework 1a that has a 3D network structure, the metal fine-particles 3 may be prevented from aggregating and falling off with aging, and are excellent in long-term preservability. Even in repeated use of the nano-composite 10, aggregation and falling-off of the metal fine-particles 3 are suppressed.

In the nano-composite 10 having the above composition, the metal fine-particles 3 are 3D-dispersed and uniformly in the matrix layer 1 having a 3D network structure while maintaining the inter-particle distance L equal to or greater than a certain value. For this reason, the LSPR absorption spectrum not only is sharp, but also is very stable and excellent in reproducibility and reliability. Further, since most of the surface of the metal fine-particle 3 is exposed in the voids 1b in the matrix layer 1 communicating with the external space, it is possible to sufficiently exhibit the characteristic of the metal fine-particles 3 that the resonance wavelength varies with the variation in the dielectric constant (or refractive index) of the medium surrounding the fine-particles 3. Accordingly, the nano-composite 10 is suitable for use in various sensing devices such as dew condensation sensors, humidity sensors and so on, and high-precision detection based on a simple constitution becomes possible.

Next, a fabrication method of the nano-composite 10 is described in detail.

<Fabrication Method of Nano-Composite>

A fabrication method of the nano-composite 10 is roughly classified into (I) a method that disperses the metal fine-particles 3 in a step of forming the matrix layer 1, and (II) a method that disperses the metal fine-particles 3 in a preformed matrix layer 1. In view of decreasing the fabrication steps thereof, the method (I) is preferred.

The method (I) may include the following steps Ia) to Id):

Ia) preparing a slurry containing an aluminum oxyhydroxide or an alumina hydrate for forming the solid framework 1a;

Ib) mixing the slurry with a metal compound as a raw material of the metal fine-particles 3 to prepare a coating liquid, wherein the metal compound has an amount, in terms of the metal element (meaning the amount of the metal element in the metal compound being converted to the weight of the metal, in this specification), in the range of 0.5 to 480 weight parts relative to 100 weight parts of the solid content of the slurry;

Ic) coating the coating liquid on a substrate and drying the same to form a coated film; and

Id) subjecting the coated film to a heating treatment to form, from the coated film, the matrix layer 1 including the solid framework 1a having a 3D structure and the voids 1b defined by the solid framework 1a, and simultaneously to heat-reduce the metal ion of the metal compound to precipitate particle-like metal as the metal fine-particles 3.

The method (II) may include the following steps IIa) to IId):

IIa) preparing a slurry containing an aluminum oxyhydroxide or an alumina hydrate for forming the solid framework 1a;

IIb) coating the slurry on a substrate, drying and then subjecting the coated slurry to a heating treatment to form the matrix layer 1 including the solid framework 1a with a 3D network structure and the voids 1b defined by the solid framework 1a;

IIc) impregnating the matrix layer 1 with a solution containing a metal ion as a raw material of the metal fine-particles 3, wherein the metal ion has an amount, in terms of the metal element, in the range of 0.5 to 480 weight parts relative to 100 weight parts of the solid content of the slurry; and

IId) reducing the metal ions to precipitate particle-like metal as the metal fine-particles 3 through a heating treatment after the step IIc.

In the following, each step in the methods (I) and (II) is specifically described. However, the parts common to both methods are explained at the same time. Here, a representative example is given in which the solid framework 1a in the matrix layer 1 are composed of boehmite (including pseudo-boehmite).

The solid framework 1a constituting the matrix layer 1 may be suitably made from a commercially available boehmite powder containing an aluminum oxyhydroxide (or alumina hydrate). For example, Boehmite (trade name) produced by Taimei Chemicals Co., Ltd., Disperal HP 15 (trade name) by CNDEA Corporation, VERSAL™ ALUMINA (trade name) by Union Showa K.K., Celasule (trade name) by Kawai Lime Industry Co., Ltd., CAM9010 (trade name) by TOMOE Engineering Co., Ltd., Aluminasol 520 (trade name) by Nissan Chemical Industries, Ltd., Aluminasol-10A (trade name) by Kawaken Fine Chemicals Co., Ltd., and so on may be used.

The boehmite (Boehmite) used in an embodiment of the invention refers to fine-particles of an aluminum oxyhydroxide (AlOOH) or an alumina hydrate (Al₂O₃.H₂O) having high crystallinity, while pseudo-boehmite refers to boehmite fine-particles that have low crystallinity. Nevertheless, both are described as boehmite in a broader sense without distinction. This boehmite powder may be produced by well-known methods such as neutralization of an aluminum salt, hydrolysis of an aluminum alkoxide, and so on. Since the boehmite powder is insoluble in water and resistant to organic solvents, acids and alkalis, it may be advantageously utilized as a component for constituting the solid framework 1a of the matrix layer 1. In addition, since the boehmite powder is characterized by having high dispersibility in an acidic aqueous solution, preparing a slurry of the boehmite powder is easy. The boehmite powder used preferably has a particle shape of, e.g., a cubic shape, a needle shape, a rhombic plate shape, an intermediate shape of these shapes, or a wrinkled-sheet, etc., and has a mean particle diameter in the range of 10 nm to 2 μm. The solid framework 1a is formed by bonding the end faces or surfaces of the fine-particles to form a 3D network structure. Further, the mean particle diameter of the boehmite powder is derived by a laser diffraction method here.

The slurry containing the boehmite powder is obtained by mixing the boehmite powder with water or a polar solvent such as alcohol and then adjusting the mixed solution to acidic. In the method (I), the coating liquid is prepared by adding the metal compound as a raw material of the metal fine-particles 3 to this slurry and evenly mixing the same.

The preparation of the slurry is performed by dispersing the boehmite powder in water or a solvent such as a polar organic solvent, and the boehmite powder used is preferably made in the range of 5 to 40 weight parts and more preferably in the range of 10 to 25 weight parts, relative to 100 weight parts of the solvent. The solvent used is, e.g., water, methanol, ethanol, glycerol, N,N-dimethylformamide, N,N-dimethyl-acetamide (DMAc), N-methyl-2-pyrrolidone, etc. It is also possible that two or more of these solvents are used in combination. In order to improve the dispersibility of the boehmite powder, the mixed solution is desirably subjected to a dispersion treatment. The dispersion treatment may be performed by, for example, stirring at room temperature for 5 minutes or longer, using an ultrasonic wave, and so on.

To enable even dispersion of the boehmite powder, the pH of the mixed solution is adjusted to 5 or less as needed. In this case, as a pH control agent, an organic acid such as formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, terephthalic acid, glutaric acid, gluconic acid, lactic acid, aspartic acid, glutaminic acid, pimelic acid, suberic acid, etc., an inorganic acid such as hydrochloric acid, nitric acid, phosphoric acid, etc., or a salt of these acids, for example, may be added properly. These pH control agents may be used alone or in combination of two or more. The particle diameter distribution of the boehmite powder may vary due to addition of the pH control agent, as compared with the case without addition of a pH control agent. Nevertheless, there is no particular problem.

In the method (I), the coating liquid is obtained by further adding the metal compound as a raw material of the metal fine-particles 3 in the slurry prepared as above. In this case, the amount of the metal compound added is made, in terms of the metal element, in the range of 0.5 to 480 weight parts relative to 100 weight parts of the solid content of the slurry. Furthermore, when the metal compound is added to the prepared slurry, the viscosity of the coating liquid may be increased. In such case, the optimal viscosity is desirably achieved by a proper addition of the above solvent.

The metal compound contained in the coating liquid prepared in the method (I) or the metal compound contained in the metal-ion containing solution prepared in the method (II) may be any compound containing the metal species constituting the metal fine-particles 3 with no particular limitation. The metal compound may be a salt or an organic carbonyl complex of an above metal. Examples of the salts of the metals include hydrochloride salts, sulfate salts, acetate salts, oxalate salts, citrate salts, and so on. In addition, examples of the organic carbonyl compounds capable of forming the above metal species and organic carbonyl complexes include β-diketones such as acetylacetone, benzoylacetone and dibenzoylmethane, and β-keto carboxylic esters such as ethyl acetoacetate.

Preferred specific examples of the metal compound include H[AuCl₄], Na[AuCl₄], AuI, AuCl, AuCl₃, AuBr₃, NH₄[AuCl₄].n2H₂O, Ag(CH₃COO), AgCl, AgClO₄, Ag₂CO₃, AgI, Ag₂SO₄, AgNO₃, Ni(CH₃COO)₂, Cu(CH₃COO)₂, CuSO₄, CuSO₄, CuSO₄, CuCl₂, CuSO₄, CuBr₂, Cu(NH₄)₂Cl₄, CuI, Cu(NO₃)₂, Cu(CH₃COCH₂COCH₃)₂, CoCl₂, CoCO₃, CoSO₄, Co(NO₃)₂, NiSO₄, NiCO₃, NiCl₂, NiBr₂, Ni(NO₃)₂, NiC₂O₄, Ni(H₂PO₂)₂, Ni(CH₃COCH₂COCH₃)₂, Pd(CH₃COO)₂, PdSO₄, PdCO₃, PdCl₂, PdBr₂, Pd(NO₃)₂, Pd(CH₃COCH₂COCH₃)₂, SnCl₂, IrCl₃, RhCl₃ and so on.

To improve the strength, transparency, glossiness and so on of the matrix layer 1, a binder component may be mixed in the prepared slurry or coating liquid as needed. Suitable examples of the binder component that may be used in combination with the aluminum oxyhydroxide include: polyvinyl alcohol or modified products thereof; gum Arabic; cellulose derivatives, such as carboxymethyl cellulose, hydroxyethyl cellulose and so on; vinyl copolymer latexes, such as SBR latex, NBR latex, functional group-modified polymer latex, ethylene vinyl acetate copolymer and so on; water-soluble cellulose; polyvinylpyrrolidone; gelatin or modified products thereof, starch or modified products thereof; casein or modified products thereof; maleic anhydride and copolymers thereof; acrylate ester copolymer; polyacrylic acid and copolymers thereof; polyamic acid (precursor of polyimide); and silane compounds, such as tetraethoxysilane, 3-aminopropyltriethoxysilane, 3-aminopropyltrimethoxysilane, N-2-(aminoethyl)-3-aminopropyltrimethoxysilane, N-2-(aminoethyl)-3-aminopropylmethyldimethoxysilane, 3-triethoxysilyl-N-(1,3-dimethylbutylidene)propylamine, N-phenyl-3-aminopropyltrimethoxysilane, and so on. These binder components may be used alone or in combination of two or more. Furthermore, with or without a metal compound, these binder components may be mixed properly, in an amount preferably in the range of 3 to 100 weight parts and more preferably 4 to 20 weight parts relative to 100 weight parts of the solid content of the slurry.

If required, it is also possible to add to the slurry or coating liquid, in addition to the binder, a dispersant, a thickener, a lubricant, a fluidity modifier, a surfactant, a defoaming agent, a water resistant agent, a releasing agent, a fluorescent whitening agent, an ultraviolet absorbent, an anti-oxidant and so on, in a range of not impairing the effects of the invention.

The method of coating the coating liquid containing the metal compound or the slurry not containing the metal compound is not particularly limited, and may be performed using, e.g., a lip coater, a knife coater, a comma coater, a blade coater, an air knife coater, a roll coater, a curtain coater, a bar coater, a gravure coater, a die coater, a spin coater, a spray, etc.

The substrate used in the coating is not particularly limited in a case where the nano-composite 10 is used in a sensor or the like after being peeled off from the substrate, or in a case utilizing light-reflection LSPR with the nano-composite 10 being attached to the substrate. In the case utilizing light-transmission LSPR with the nano-composite 10 being attached to the substrate, the substrate is preferably light transmitting, and is, e.g., a glass substrate, or a transparent synthetic resin substrate, etc. Examples of the transparent synthetic resin include: polyimide resin, PET resin, acrylic resin, MS resin, MBS resin, ABS resin, polycarbonate resin, silicone resin, siloxane resin, epoxy resin, and so on.

After the coating liquid containing the metal compound or the slurry not containing the metal compound is coated, it is dried to form a coated film. The drying method is not particularly limited, possibly including heating at a temperature of, e.g., 60 to 150° C. Nevertheless, the drying is preferably performed at a temperature of 60 to 150° C. for 1 to 60 minutes.

After the coating liquid containing the metal compound or the slurry not containing the metal compound is coated and dried, it is subjected to a heating treatment preferably at 150 to 450° C. and more preferably at 170 to 400° C., thereby forming the matrix layer 1. When the temperature of the heating treatment is lower than 150° C., the formation of the 3D network structure of the matrix layer 1 may not be sufficient. When the temperature of the heating treatment exceeds 450° C., for example, in a case where Au or Ag is used as the material of the metal fine-particles 3, melting of the metal fine-particles 3 occurs so that the resulting particle diameter D becomes larger and achieving a sufficient LSPR effect becomes difficult.

In the above method (I), it is possible to form the matrix layer 1 and at the same time form and disperse the metal fine-particles 3 through reduction of the metal ion by one heating step. In the method (II), after the matrix layer 1 is formed, the matrix layer 1 is impregnated with a solution containing a metal ion and then heated to reduce the metal ion, so as to form and disperse the metal fine-particles 3.

In the metal ion-containing solution used in the above method (II), the metal ion is preferably contained, in terms of the metal element, in the range of 1 to 20 wt %. By limiting the concentration of the metal ion in the above range, it is possible to make the metal ion have an amount, in terms of the metal element, in the range of 0.5 to 480 weight parts relative to 100 weight parts of the solid content of the slurry.

The impregnation method in the above method (II) is not particularly limited as long as it enables at least a surface of the resulting matrix layer 1 to be in contact with the metal ion-containing solution, and may be a well-known method, such as, an immersion method, a spray method, a brush-painting method or a printing method, etc. The impregnation temperature may be 0 to 100° C., and preferably a normal temperature around 20 to 40° C. In addition, the impregnation is expected to take, e.g., 5 seconds or longer, in the case of applying an immersion method.

The reduction of the metal ion and the dispersion of the precipitated metal fine-particles 3 are performed by a heating treatment preferably at 150 to 450° C. and more preferably at 170 to 400° C. When the temperature of the heating treatment is lower than 150° C., the reduction of the metal ion is not sufficiently performed, and it may be difficult to make the mean particle diameter of the metal fine-particles 3 equal to or greater than the above lower limit (3 nm). In addition, when the temperature of the heating treatment is lower than 150° C., the thermal diffusion of the metal fine-particles 3 precipitated through the reduction may not be sufficient.

The formation of the metal fine-particles 3 through heat-reduction is described herein. The particle diameter D and the inter-particle distance L of the fine-particles 3 may be controlled by the heating temperature and heating time in the reduction step and the content of the metal ion in the matrix layer 1. The inventors have discovered that in the case where the heating temperature and heating time in the heat-reduction are constant, when the absolute amount of the metal ion in the matrix layer 1 differs, the particle diameter D of the metal fine-particles 3 being precipitated differs. In addition, it has also been discovered that in the case where heat-reduction is performed without controlling the heating temperature and the heating time, the inter-particle distance L is smaller than the particle diameter D_{L} of the larger one of neighboring fine-particles 3.

In addition, it is also possible to apply the above findings, for example, to divide the thermal treatment in the reduction step into plural steps for execution. For example, it is possible to perform a particle diameter control step of enabling the fine-particles 3 to grow to a predetermined particle diameter D at a first heating temperature, and an inter-particle distance control step of making the inter-particle distance L of the metal fine-particles 3 reach a predetermined range at a second heating temperature the same as or different from the first heating temperature. In this way, the particle diameter D and the inter-particle distance L may be more precisely controlled by adjusting the first and second heating temperatures and the heating time.

Heat-reduction is adopted as the reduction method for its industrial advantages, such as that the particle diameter D and the inter-particle distance L may be relatively easily controlled by controlling the reduction conditions (especially heating temperature and heating time), that simple equipment is applicable from lab scale to production scale without particular limitation, and that heat-reduction may be performed in a single-piece or continuous manner without special efforts, etc. Heat-reduction may be performed in an inert gas atmosphere such as Ar and N₂, in a vacuum of 1 to 5 KPa, or in the atmosphere. Vapor-phase reduction using a reductive gas such as hydrogen gas may also be utilized.

In heat-reduction, the metal ion present in the matrix layer 1 is reduced, and the metal fine-particles 3 may be independently precipitated due to thermal diffusion. The metal fine-particles 3 formed in this way maintain the inter-particle distance L equal to or larger than a certain value, and have shapes that are substantially uniform. The metal fine-particles 3 are 3D-dispersed uniformly in the matrix layer 1. Especially, in the case of performing the reduction by this step, the shapes and the particle diameters D of the metal fine-particles 3 are uniformized, so that a nano-composite 10 in which the metal fine-particles 3 are evenly precipitated and dispersed in the matrix layer 1 with a substantially uniform inter-particle distance L is obtained. In addition, by controlling the structural units of the inorganic oxide constituting the matrix layer 1 or controlling the absolute amount of the metal ion and the volume fraction of the metal fine-particles 3, the particle diameter D of the metal fine-particles 3 and the distribution state of the metal fine-particles 3 in the matrix layer 1 may also be controlled.

In the above way, the nano-composite 10 may be fabricated. Further, in a case where an inorganic oxide other than boehmite is used as the matrix layer 1, the above fabrication method may also be used.

### First Embodiment

### Dew Condensation Sensor

Next, a dew condensation sensor according to the first embodiment of the sensor element of the invention is described with reference to FIGS. 5 to 9. FIG. 5 illustrates a schematic configuration of a dew condensation sensor 100 according to an embodiment of the invention. The dew condensation sensor 100 includes a nano-composite 10, a light reflective member 20 disposed on one side of the nano-composite 10, a protection layer 30 laminated on the light reflective member 20, a light source/light receiver 40 disposed facing the nano-composite 10, a spectroscope (or photo-detector) 50 detecting light reflected by the light source/light receiver 40, a controller 60 connected to the light source/light receiver 40 and the spectroscope (or photo-detector) 50 and used for overall control thereof, and a display unit 70 connected to the controller 60. In the dew condensation sensor 100, the nano-composite 10, the light reflective member 20 and the protection layer 30 constitute a “plasmon resonance generating unit” that generates LSPR. Furthermore, the protection layer 30 has an arbitrary structure, and may not be disposed.

In addition, the dew condensation sensor 100 is accommodated in a housing 101. The housing 101 has a gas inlet 101A and a gas outlet 101B, with a space S formed therebetween for circulating a measurement object gas. Furthermore, the housing 101 has an arbitrary structure, and may not be disposed.

The nano-composite 10 employed in the dew condensation sensor 100 of the present embodiment has the above constitution (also referring to FIGS. 1 to 4). As shown in FIG. 5, the nano-composite 10 used in this embodiment includes a first surface (light receiving surface) 10A receiving light emitted from the light source/light receiver 40, and a second surface (rear surface) 10B formed opposite to the first surface 10A. Also, the light reflective member 20 is disposed in contact with the second surface 10B.

[Light Reflecting Member]

The light reflecting member 20 includes a light transmitting layer 21, and a metal layer 23 laminated on this light transmitting layer 21. The light transmitting layer 21 may be formed from a material transmitting light of a wavelength (e.g., in the range of 300 to 900 nm in a case where the metal fine-particles 3 include gold or silver) that induces LSPR. Examples of such material include: an inorganic transparent substrate of glass or quartz, etc., a transparent conductive film of indium tin oxide (ITO) or zinc oxide, etc., or a transparent synthetic resin such as polyimide resin, PET resin, acrylic resin, MS resin, MBS resin, ABS resin, polycarbonate resin, silicone resin, siloxane resin or epoxy resin, etc.

The metal layer 23 is a film of a metal material such as silver, aluminum, silicon, titanium, chromium, iron, manganese, cobalt, nickel, copper, zinc, tin or platinum, etc. Among these metal materials, aluminum is most preferred as the material of the metal layer 23 due to high optical reflectivity, high oxidation resistance, and high adhesion to the light transmitting layer 21. The metal layer 23 may be formed as a film on one surface of the light transmitting layer 21 by a method such as sputtering, CVD, evaporation, coating, ink-jet coating, electroless plating, or electroplating, etc.

Furthermore, although FIG. 5 shows, as an example of the light reflecting member 20, a laminated object obtained by laminating the light transmitting layer 21 and the metal layer 23, the light reflecting member 20 may be anything capable of reflecting light of the above wavelength. For example, a mirror-finished metal plate or the like may be used as the light reflecting member 20.

In addition, the nano-composite 10 and the light reflecting member 20 are not necessarily disposed in close contact with each other. The light reflecting member 20 may be disposed apart from the nano-composite 10 by any distance.

[Protection Layer]

The protection layer 30 provides protection by covering the metal layer 23 from the outside. The protection layer 30 prevents the metal layer 23 from oxidation in the heating treatment performed in the fabrication of the nano-composite 10. Accordingly, in a case where the metal layer 23 includes a metal species difficult to be oxidized, disposing the protection layer 30 is not necessary. The protection layer 30 may be formed from a material having thermal resistance and oxidation resistance, or a material having a barrier property suppressing oxygen permeation, etc. From such viewpoint, the protection layer 30 is made of, e.g., a metal material such as nickel, chromium or a Ni—Cr alloy, etc., an inorganic material such as glass, etc., or a highly thermo-resistant organic material such as polyimide resin or epoxy resin, etc. Among these, nickel, chromium and Ni—Cr alloy that particularly have high thermal resistance and high oxidation resistance are preferred. The protection layer 30 may be formed as a film on the surface of the metal layer 23 by a method such as sputtering, CVD, evaporation, coating, ink-jet coating, electroless plating, or electroplating, etc.

In the dew condensation sensor 100, in view of increasing the detection sensitivity of the LSPR, the thickness of the nano-composite 10 is preferably set to be, e.g., in the range of 30 nm to 10 μm.

In addition, although the thickness of the light transmitting layer 21 is not particularly limited, it may be set to be, e.g., in the range of 1 μm to 10 mm.

Although the thickness of the metal layer 23 is not particularly limited, it may be set to be, e.g., in the range of 50 nm to 10 μm.

Further, in the case where the protection layer 30 is disposed, in order to provide a sufficient oxidation preventing function for the metal layer 23, the thickness thereof is preferably set to be, e.g., in the range of 100 nm to 10 μm.

[Light Source/Light Receiver]

The light source/light receiver 40 includes a light source 40A and a light receiver 40B. The light source 40A is applicable without particular limitation as long as it is capable of emitting light of a wavelength (e.g., in the range of 300 to 900 nm in the case where the metal fine-particles 3 include gold or silver) that induces LSPR in the nano-composite 10, regardless of its type. As a preferred light source 40A, for example, a halogen lamp, a xenon lamp, an LED, a tungsten-halogen lamp, a fluorescent lamp, a mercury lamp, a krypton lamp, a metal-halide lamp, a sodium-vapor lamp, an HID lamp, an EL lamp, etc. may be mentioned. The light receiver 40B includes, e.g., a light concentrator receiving reflected light and a light receiving probe (not shown) provided with an optical fiber. Further, the light source 40A and the light receiver 40B may be disposed separately, and are not limited to have the configuration in which the light from the light source 40A is perpendicularly incident relative to the surface of the nano-composite 10. The light receiver 40B may be arranged to receive the reflected part of light incident to the surface at any angle.

[Spectroscope (or Photo-Detector)]

The spectroscope (or photo-detector) 50 is connected to the light receiver 40B by an optical connecting means such as an optical fiber or the like. The spectroscope (or photo-detector) 50 may make a selection depending on its measurement purpose. That is to say, the spectroscope is capable of measuring the absorption spectrum of the reflected light of LSPR transmitted from the light receiver 40B, or the photo-detector is capable of measuring the intensity of light transmitted from the light receiver 40B.

[Controller]

The controller 60 includes computer functions and performs analysis or arithmetic processing and so on based on data of the absorption spectrum (or the intensity) of the reflected light of LSPR detected by the spectroscope (or photo-detector) 50. The controller 60 may also be provided with, e.g., a hard disk drive or a memory means including nonvolatile memory (flash memory element, etc.) or volatile memory (e.g., RAM, etc.) that are not illustrated. In addition, based on an analysis result of the reflected light, the controller 60 transmits the detected situation of dew condensation as an electrical signal to the display unit 70.

[Display Unit]

The display unit 70 displays an occurrence of dew condensation as, e.g., text or an image on a monitor, based on a signal from the controller 60. Further, as an alternative to monitor display, e.g., notification via a lamp, or an alert sound, etc., is also possible.

While the measurement object gas is circulated through the dew condensation sensor 100 with the above configuration in the space S, as schematically shown by dashed arrows in FIG. 5, light is emitted continuously or intermittently from the light source 40A of the light source/light receiver 40 to a plasmon resonance generating unit having the nano-composite 10. A part of the emitted light is reflected at the first surface 10A of the nano-composite 10, and the other part passes through the inside of the network structure of the nano-composite 10 and is reflected by the metal layer 23 of the light reflecting member 20. These parts of reflected light are detected by the light receiver 40B of the light source/light receiver 40 to measure the LSPR absorption spectrum (or the intensity of the reflected light) using the spectroscope (or photo-detector) 50. The data of these is analyzed by the controller 60 as needed, and displayed on the display unit 70 as the detection information of dew condensation.

The dew condensation sensor 100 includes the nano-composite 10 in which the metal fine-particles 3 are 3D-dispersed uniformly in the matrix layer 1 having a 3D network structure while maintaining the inter-particle distance L equal to or greater than a certain value. For this reason, the LSPR absorption spectrum not only is sharp, but also is very stable and excellent in reproducibility and reliability, and is thus capable of detecting occurrence of dew condensation in high sensitivity. In addition, since the 3D network structure has an effect of facilitating dew condensation, dew condensation occurs inside the matrix layer 1 having a 3D network structure at a temperature higher than a dew point. Further, in addition to the surface-reflected light at the first surface 10A of the nano-composite 10, the reflected light at the light reflecting member 20 is also measured, so that the detection sensitivity is considerably increased as compared to a method of only measuring the surface-reflected light. In this way, compared to a mirror-cooling dew condensation sensor, the dew condensation sensor 100 utilized LSPR not only is very highly sensitive, but also is capable of detecting dew condensation on a higher-temperature side rapidly and accurately, and thus is useful as a preventive sensor for dew condensation. In addition, by utilizing the reflected light at the light reflecting member 20 in addition to the surface-reflected light, the entire apparatus may be downsized. Moreover, since it is possible to decrease the amount of irradiation light required for the LSPR absorption with the same intensity, measurement with high sensitivity but low power consumption may be realized.

[Determination of Dew Condensation]

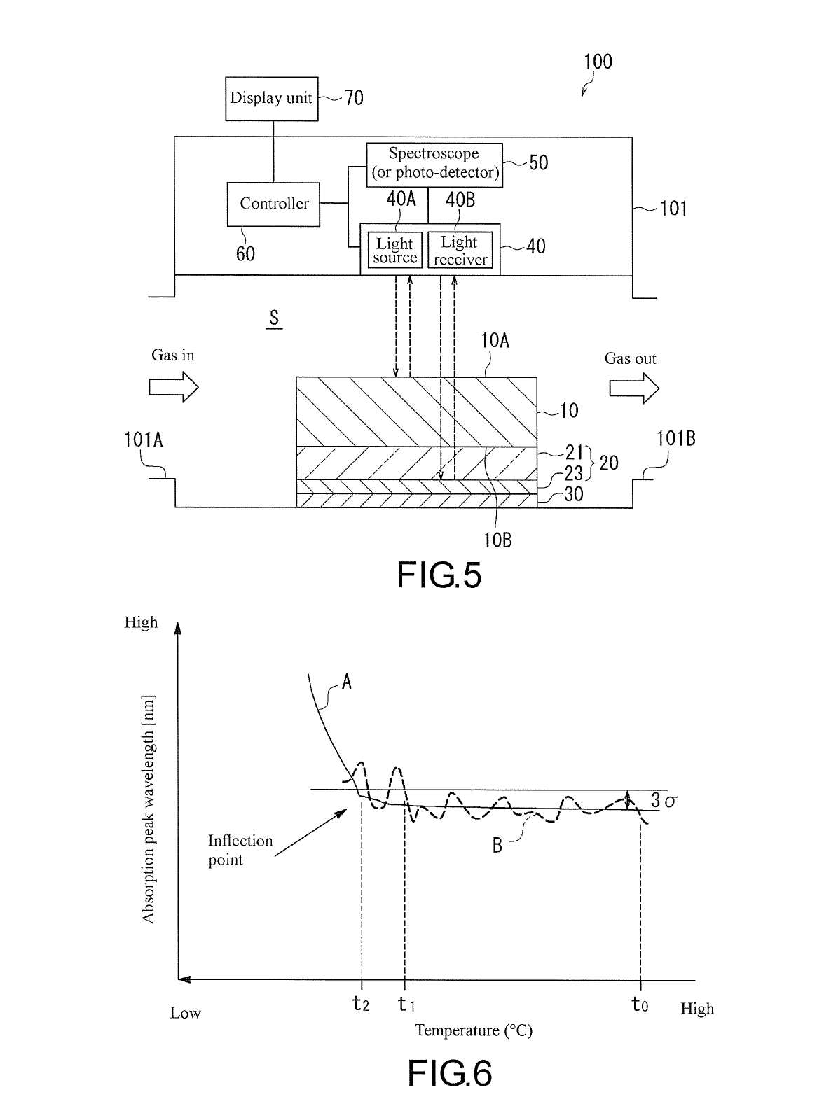

For the dew condensation sensor 100, though a method of determining occurrence of dew condensation is arbitrary, a method of evaluation based on the variation in the absorption peak wavelength calculated from the LSPR absorption spectrum may be taken as an example. A description in regard to the occurrence of dew condensation (determination of the dew point) in this case is given with reference to FIG. 6. FIG. 6 conceptually shows a relationship between the absorption peak wavelength of the LSPR absorption spectrum measured by the spectroscope 50 and the temperature variation. In FIG. 6, a thin curve A shows variation in the absorption peak wavelength, and a thick dashed line B is obtained by greatly magnifying a vertical axis of the curve A and shows detailed variation in the absorption peak wavelength while the temperature is lowered from t₀ to t₂. That is to say, in reality, the absorption peak wavelength of the LSPR absorption spectrum measured by the spectroscope 50 changes like the curve A while repeating minute fluctuations like the dashed line B.

In the curve A, in a case where the temperature is gradually lowered from t₀, the absorption peak wavelength rapidly varies with the temperature t₂ as an inflection point. For this reason, the temperature t₂ at which the slope of the curve A varies in excess of a predetermined threshold value may be determined as the occurrence of dew condensation (or a dew point). The threshold value of slope at the inflection point used for this determination is a value preset based on, e.g., back data, and stored in the memory means of the controller 60. The determination may be accomplished by reading out the value and comparing it with the slope of the curve A obtained by the measurement data of the newest absorption peak wavelength in real time. In this way, the dew condensation sensor 100 of this embodiment is useful as a dew condensation sensor with highly-sensitive responsiveness to the occurrence of dew condensation.

In another determination method, for example, in an arbitrary section of the period from t₀ to t₂ in which the absorption peak wavelength is in an approximately steady state, the standard deviation σ of the absorption peak wavelength and the mean value ν of the absorption peak wavelength are sequentially monitored, and the temperature t₁ at which the absorption peak wavelength varies in excess of ν±3σ for the first time can be determined as the occurrence point of dew condensation (or dew point). The values of the standard deviation n and the mean value ν of the absorption peak wavelength used for this determination are sequentially computed using the controller 60 and then sequentially updated and stored by the memory means thereof. Thus, through real-time comparison of the measurement result of the newest absorption peak wavelength with the ν±3σ value based on the history information of the absorption peak wavelength measured before, a determination may be accomplished. In addition, by inputting a standard deviation σ₀ of the absorption peak wavelength in a standard state and a mean value νₒ of the same in the standard state in advance, the dew point may also be determined by comparing the information of ν₀±3σ₀ with the measurement result of the absorption peak wavelength. In this way, the dew condensation sensor 100 of this embodiment is applicable as a dew condensation sensor for predicting occurrence of dew condensation beforehand.

Moreover, in place of the absorption peak wavelength of the LSPR absorption spectrum, the amount of the variation in absorption peak intensity, or the amount of the variation in the absorption intensity or the intensity of the reflected light at a specific wavelength may also serve as the basis for determination. As the specific wavelength, a wavelength at which the absorption intensity or the reflected-light intensity varies may be selected. Particularly, a wavelength at which the amount of the variation in the intensity is large is preferably selected. For example, in a case where the solid framework 1a in the matrix layer 1 is composed of boehmite and the metal fine-particles 3 are composed of gold, depending on the thickness of the matrix layer 1 or the particle diameter D and the inter-particle distance L of the metal fine-particles 3, a wavelength of roughly 700 nm is suitably selected.

In addition, although the dew condensation sensor 100 in FIG. 5 has a constitution provided with the controller 60 and the display unit 70, by enabling the spectroscope (or photo-detector) 50 to perform analysis or arithmetic processing of the absorption spectrum and display results thereof, the controller 60 and the display unit 70 may be omitted.

[Fabrication of Plasmon Resonance Generating Unit]

The plasmon resonance generating unit in the dew condensation sensor 100, for example, may be made by the following two methods. In the first method, the light reflecting member 20 (possibly including the protection layer 30) is used in place of the substrate used in the method of making the nano-composite 10. For example, a laminated object is prepared by laminating the light transmitting layer 21, the metal layer 23 and the protection layer 30 in sequence. Then, for example, after the coating liquid obtained by mixing the slurry for forming the solid framework 1a with the metal compound is coated on the surface of the light transmitting layer 21, formation of the matrix layer 1 including the solid framework 1a and the voids 1b and precipitation of the metal fine-particles 3 may be carried out through a heating treatment (referring to FIGS. 1 to 3). Or, for example, after the slurry for forming the solid framework 1a is coated on the surface of the light transmitting layer 21 to form the matrix layer 1 including the solid framework 1a and the voids 1b, precipitation of the fine-particles 3 may be carried out by impregnating the matrix layer 1 with the metal ion-containing solution (FIGS. 1 to 3). By using the light reflecting member 20 (possibly including the protection layer 30) as a substrate like this, the plasmon resonance generating unit may be fabricated concurrently with fabrication of the nano-composite 10. At this moment, in a case where the metal layer 23 includes a metal easily oxidized by heating, by disposing the protection layer 30 on the light reflecting member 20 in advance, oxidation of the metal material of the metal layer 23 and degradation in light reflection due to the heating treatment may be effectively avoided.

In the second method of fabricating the plasmon resonance generating unit in the dew condensation sensor 100, the nano-composite 10 and the light reflecting member 20 are respectively fabricated, and then the nano-composite 10 is arranged and fixed overlapping the surface of the light transmitting layer 21 of the light reflecting member 20. In this case, the nano-composite 10 and the light reflecting member 20 are, for example, fixed by any means (e.g., through adhesion using an adhesive, or adhesion with pressing, etc.) to a periphery of the nano-composite 10 so as to not affect the occurrence of LSPR. In addition, due to absence of a heating treatment to the metal layer 23 of the light reflecting member 20, the protection layer 30 may be omitted.

[Application Examples of Dew Condensation Sensor]

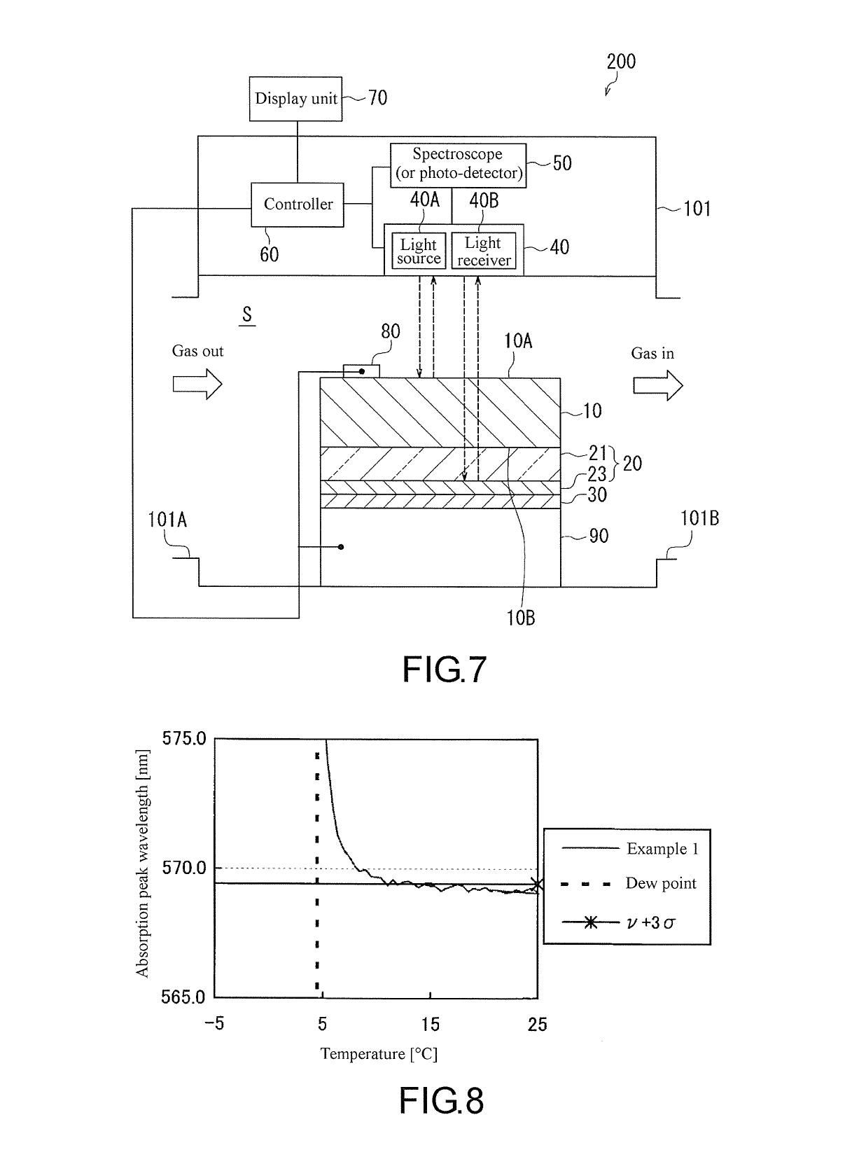

The dew condensation sensor of this embodiment is also applicable as a dew point meter (dew point measurement device) by having a temperature control function and a temperature measurement function. FIG. 7 illustrates a schematic constitution of a dew point meter 200 that utilized the dew condensation sensor 100 of this embodiment. Moreover, the same components as in FIG. 5 have the same reference numerals in FIG. 7, and descriptions thereof are omitted. This dew point meter 200 includes, in addition to the components of the dew condensation sensor 100 in FIG. 5 [namely, the nano-composite 10, the light reflecting member 20, the protection layer 30, the light source/light receiver 40, the spectroscope (or photo-detector) 50, the controller 60 and the display unit 70], a temperature measurement device 80 such as a thermocouple for measuring the temperature of the nano-composite 10, and a temperature control device 90 such as a Peltier element for adjusting the temperature of the nano-composite 10. The temperature measurement device 80 and the temperature control device 90 are electrically connected to the controller 60 to be controlled. The temperature measurement device 80 is installed on a surface of (or inside) the nano-composite 10. The temperature control device 90 is arranged below the nano-composite 10 so as to perform a heat exchange with the nano-composite 10 through the light reflecting member 20 and the protection layer 30.

In the dew point meter 200, while the nano-composite 10 is decreased in temperature by the temperature control device 90 at a predetermined rate, the measurement object gas is circulated in the space S. In addition, as schematically shown by broken lines in FIG. 7, light is emitted continuously or intermittently from the light source 40A of the light source/light receiver 40 to the plasmon resonance generating unit having the nano-composite 10. A part of the emitted light is reflected at the first surface 10A of the nano-composite 10, and the other part passes through the inside of the network structure of the nano-composite 10 and is reflected by the metal layer 23 of the light reflecting member 20. The reflected light is detected by the light receiver 40B of the light source/light receiver 40 to measure the LSPR absorption spectrum (or the intensity of the reflected light) using the spectroscope (or photo-detector) 50. Occurrence of dew condensation may be determined from the shift amount of the peak wavelength of the absorption spectrum, the amount of the variation in the peak intensity, the amount of the variation in the absorption intensity or the amount of the variation in the reflected light intensity at a specific wavelength using the same method for the dew condensation sensor 100 in FIG. 5.

Meanwhile, the temperature of the nano-composite 10 is measured in real time by the temperature measurement device 80 and is transmitted to the controller 60 as temperature information. By analyzing the measurement data of the temperature and the measurement data of the absorption spectrum at that temperature using the controller 60, the temperature at which dew condensation occurred is determined as the dew point. The dew point may be displayed by, e.g., the display unit 70.

As mentioned above, since the dew condensation sensor 100 of this embodiment has a nanometer-sized fine structure that has the effect of facilitating dew condensation and uses the metal fine-particle dispersed composite (nano-composite 10) that interacts with light of a specific wavelength to induce LSPR, small dew condensation may be detected promptly as an optical property variation with a simple device constitution. That is to say, because the nano-composite 10 incorporated into the dew condensation sensor 100 of this embodiment includes the matrix layer 1 having a 3D network structure including the solid framework 1a and the voids 1b defined by the solid framework 1a, and the metal fine-particles 3 are 3D-dispersed in this matrix layer 1, the intensity of the LSPR absorption spectrum is large. Furthermore, since the metal fine-particles 3 present inside the matrix layer 1 are controlled to have particle diameters D in a predetermined range and are dispersed uniformly while maintaining the inter-particle distance L, the LSPR absorption spectrum is sharp. Further, since each metal fine-particle 3 has a portion exposed in the voids 1b inside the matrix layer 1 having a network structure, it is possible to make the most of the characteristic that the resonant wavelength varies with the variation in the dielectric constant (or the refractive index) of the medium surrounding the metal fine-particles 3. In addition, since the dew condensation sensor of the present embodiment includes the light reflecting member 20, in addition to the surface-reflected light of the nano-composite 10, the reflected light at the light reflecting member 20 is also measured, so that the detection sensitivity is considerably increased as compared to a method of only measuring the surface-reflected light.

According to the dew condensation sensor 100 of this embodiment, even with respect to a gas containing a minute amount of moisture, it is possible to detect dew condensation with high sensitivity at a temperature higher than the dew point measured by the minor-cooling dew condensation sensor. Thus, the dew condensation sensor 100 of this embodiment is useful in applications for detecting the occurrence of dew condensation beforehand, such as a preventive sensor, a dew point meter and so on.

Next, the dew condensation sensor of this embodiment is described in further detail with reference to examples. However, the following examples are merely illustrative and the invention is not limited thereto. Moreover, various measurements and evaluations are based on the following unless noted otherwise.

[Measurement of Mean Particle Diameter of Metal Fine-Particles]

A measurement of a mean particle diameter of metal fine-particles was performed by cutting a cross section of a sample using a microtome (Ultracut UTC Ultramicrotome, made by Leica Camera AG) to obtain an ultrathin slice and observing the same using a TEM (JEM-2000EX, made by JEOL). Moreover, because it is difficult to observe a sample made on a glass substrate using the above method, observation was performed on a sample made in the same conditions on a polyimide film. In addition, the mean particle diameter of the metal fine-particles was defined as an area-average diameter.

[Measurement of Void Size of Metal Fine-Particle Dispersed Composite]

The average value of the void size (pore diameter) of a metal fine-particle dispersed composite was obtained by a pore distribution measurement using a mercury porosimeter method.

[Measurement of Void ratio of Metal Fine-Particle Dispersed Composite]

The void ratio of a metal fine-particle dispersed composite was calculated from the apparent density (gross density) calculated from the area, thickness and weight of the metal fine-particle dispersed composite, and the density excluding the voids (real density) calculated from the inherent densities and the composition ratio of the materials forming the solid framework of the matrix layer and the metal fine-particles, according to the following expression (A).

Void ratio (%)=(1−gross density/real density)×100 (A)

[Measurement of Reflection Absorption Spectrum of Sample]

The reflection absorption spectrum of a fabricated nano-composite sample was observed using an instantaneous multi-channel photo-detector (MCPD-3700, made by Otsuka Electronics Co., Ltd.).

### Example 1

### Fabrication of Nano-Composite

To 6 g of a boehmite powder (trade name: C-01, produced by Taimei Chemicals Co., Ltd, with a mean particle diameter of 0.1 μm and a cubic particle shape), 17 g of water and 0.5 g of acetic acid were added, and a 5-min ultrasonic treatment was performed. Further, 17 g of ethanol, 0.6 g of 3-aminopropyltriethoxysilane and 1.25 g of chloroauric acid tetrahydrate were added, followed by a 5-min ultrasonic treatment, thereby preparing a gold complex-containing slurry 1. The proportion of Au in the gold complex-containing slurry 1 at this moment was 10 weight parts relative to 100 weight parts of boehmite. Next, the resulting gold complex-containing slurry 1 was coated on a glass face of a substrate (12 cm square) having a three-layer structure of Ni—Cr alloy film of 193 nm thick/Ag film of 233 nm thick/glass substrate of 0.7 mm thick using a spin coater (trade name: Spincoater 1H-DX2, made by Mikasa Co., Ltd.), dried at 70° C. for 3 minutes and at 130° C. for 10 min, and then subjected to a heating treatment at 280° C. for 10 min, thereby fabricating a metal gold fine-particle-dispersed nano-composite 1 of 1.18 μm thick that displayed a red color. The gold fine-particles formed in the nano-composite 1 were dispersed entirely independently from each other in a region from a surface portion of the film along the thickness direction, with a distance equal to or greater than the particle diameter of the larger one of neighboring metal gold fine-particles. The characteristics of this nano-composite 1 include:

1) a void ratio of 58%, a mean void size of 8 nm, and a maximal void size of 110 nm;

2) a shape of the metal gold fine-particles being substantially spherical, a mean particle diameter of 34 nm, a minimal particle diameter of 12 nm, a maximal particle diameter of 54 nm, a proportion of 100% for the particles having particle diameters of 1 to 100 nm, a mean inter-particle distance of 117 nm, and a volume fraction of 0.66% for the metal gold fine-particles relative to the nano-composite 1; and

3) a volume fraction of 1.1% for the metal gold fine-particles in the nano-composite 1 relative to the total volume of the voids in the nano-composite 1.

In addition, the reflection absorption spectrum of the LSPR of the metal gold fine-particles in the nano-composite 1 was observed to have an absorption peak with a peak top at 565 nm, a half-height width of 157 nm, and an absorbance of 0.264 at a wavelength of 700 nm, while the absorption spectrum in water was observed to have an absorption peak with a peak top at 603 nm, a half-height width of 204 nm, and an absorbance of 0.769 at the wavelength of 700 nm. The peak wavelength variation and the peak intensity variation at the wavelength of 700 nm per unit variation of the refractive index of the observed absorption peak were 115.2 nm and 0.859, respectively.

<Evaluation of Cooling Properties>

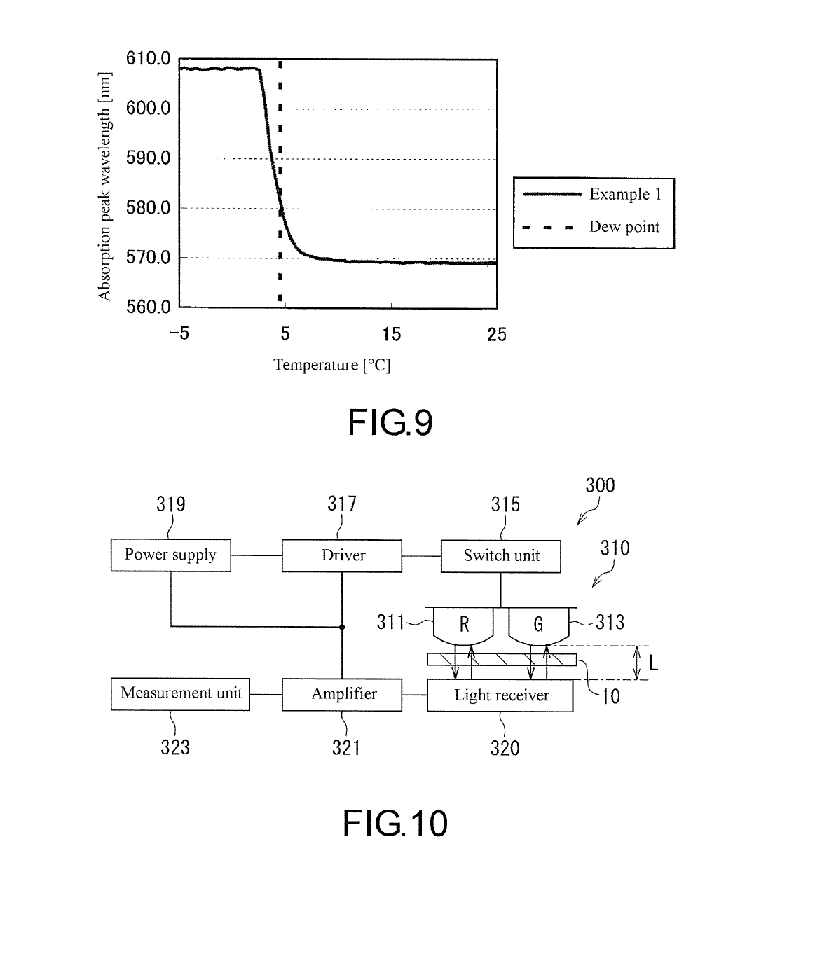

An experiment was performed in the following manner by mimicking the configuration of the dew point meter 200 shown in FIG. 7. The nano-composite 1 was cut into 1.5 cm square using a glass cutter and disposed on a Peltier element with the face where the nano-composite was formed facing upward, a thermocouple was disposed on a surface of the nano-composite 1, and the thermocouple was immobilized using a metallic jig so as to be fixed together with the nano-composite 1 to the Peltier element. The Peltier element to which the nano-composite 1 was fixed to was enclosed in a metallic container having a capacity of 73.9 cm³, while a gas “a” that controlled the amount of moisture to be constant was continuously fed to an inside of the metallic container at a flow rate of 0.5 L/min. A dew point of the gas a was measured to be 4.50±0.07° C. by a mirror-cooling dew point meter (DewStar S-2S, made by Shinyei Technology). This value was shown as the dew point in FIGS. 8 and 9.

Light from a light source (trade name: LS-1, made by Ocean Optics) was incident to the surface of the nano-composite 1, and the reflected light was received by a light receiver (trade name: QR400-7-SR, made by Ocean Optics). The temperature of the surface of the nano-composite 1 was controlled by the Peltier element to reach 25° C., and left still for 20 minutes. Next, while the nano-composite 1 was cooled by the Peltier element so as to cool the thermocouple at a rate of 0.5° C./min, the received reflected light was analyzed using a spectroscope (trade name: QE-65000, made by Ocean Optics). The standard deviation G of the absorption peak wavelength from 25° C. to 15° C. was 0.109 nm, and the mean value ν of the absorption peak wavelength was 569.170 nm. When the temperature of the surface of the nano-composite 1 reached 13.0° C., the absorption peak wavelength was shifted to a longer-wavelength side in excess of ν±3σ. A chart illustrating an evaluation method at this moment was shown in FIG. 8. In addition, when the surface temperature of the nano-composite 1 reached 8.4° C., the absorption peak wavelength and the reflected light intensity at the wavelength of 700 nm rapidly varied with 8.4° C. as the inflection point. A chart illustrating an evaluation method at this moment was shown in FIG. 9. From the above, it was confirmed that the nano-composite 1 is capable of detecting dew condensation at a temperature higher than the dew point (4.50±0.07° C.) measured using the mirror-cooling dew point meter.

### Example 2

Except that the cooling speed was set to 1.0° C./min, the cooling properties were evaluated in the same manner as in Example 1. The standard deviation G of the absorption peak wavelength from 25° C. to 15° C. was 0.113 nm, and the mean value ν of the absorption peak wavelength was 569.794 nm. When the temperature of the surface of the nano-composite 1 reached 10.6° C., the absorption peak wavelength was shifted to the longer-wavelength side in excess of σ±3σ. In addition, as the surface temperature of the nano-composite 1 reached 8.6° C., the absorption peak wavelength and reflected-light intensity at the wavelength of 700 nm rapidly varied with 8.6° C. as the inflection point. From the above, it was confirmed that the nano-composite 1 is capable of detecting dew condensation at a temperature higher than the dew point (4.50±0.07° C.) measured using the minor-cooling dew point meter.

### Example 3

Except that a gas “b” (with a dew point of −11.80±0.05° C. measured by the mirror-cooling dew point meter) was used in place of the gas a, the cooling properties were evaluated in the same manner as in Example 1. The standard deviation σ of the absorption peak wavelength from 25° C. to 15° C. was 0.136 nm, and the mean value ν of the absorption peak wavelength was 570.458 nm. When the temperature of the surface of the nano-composite 1 reached −0.5° C., the absorption peak wavelength was shifted to the longer-wavelength side in excess of σ±3σ. In addition, as the surface temperature of the nano-composite 1 reached −8.9° C., the absorption peak wavelength and the reflected light intensity at the wavelength of 700 nm rapidly varied with −8.9° C. as the inflection point. From the above, it was continued that the nano-composite 1 is capable of detecting dew condensation at a temperature higher than the dew point (−11.80±0.05° C.) measured using the mirror-cooling dew point meter.

### Example 4

Except that the cooling speed was set to 1.0° C./min instead of 0.5° C./min, and a gas c (with a dew point of −11.50±0.15° C. measured by the mirror-cooling dew point meter) was used in place of the gas a, the cooling properties were evaluated in the same manner as in Example 1. The standard deviation σ of the absorption peak wavelength from 25° C. to 15° C. was 0.221 nm, and the mean value ν of the absorption peak wavelength was 570.555 nm. When the temperature of the surface of the nano-composite 1 reached −8.2° C., the absorption peak wavelength was shifted to the longer-wavelength side in excess of ν+3σ. In addition, as the surface temperature of the nano-composite 1 reached −9.3° C., the absorption peak wavelength and the reflected light intensity at the wavelength of 700 nm rapidly varied with −9.3° C. as the inflection point. From the above, it was confirmed that the nano-composite 1 is capable of detecting dew condensation at a temperature higher than the dew point (−11.50±0.15° C.) measured using the mirror-cooling dew point meter.

### Second Embodiment

### Humidity Sensor

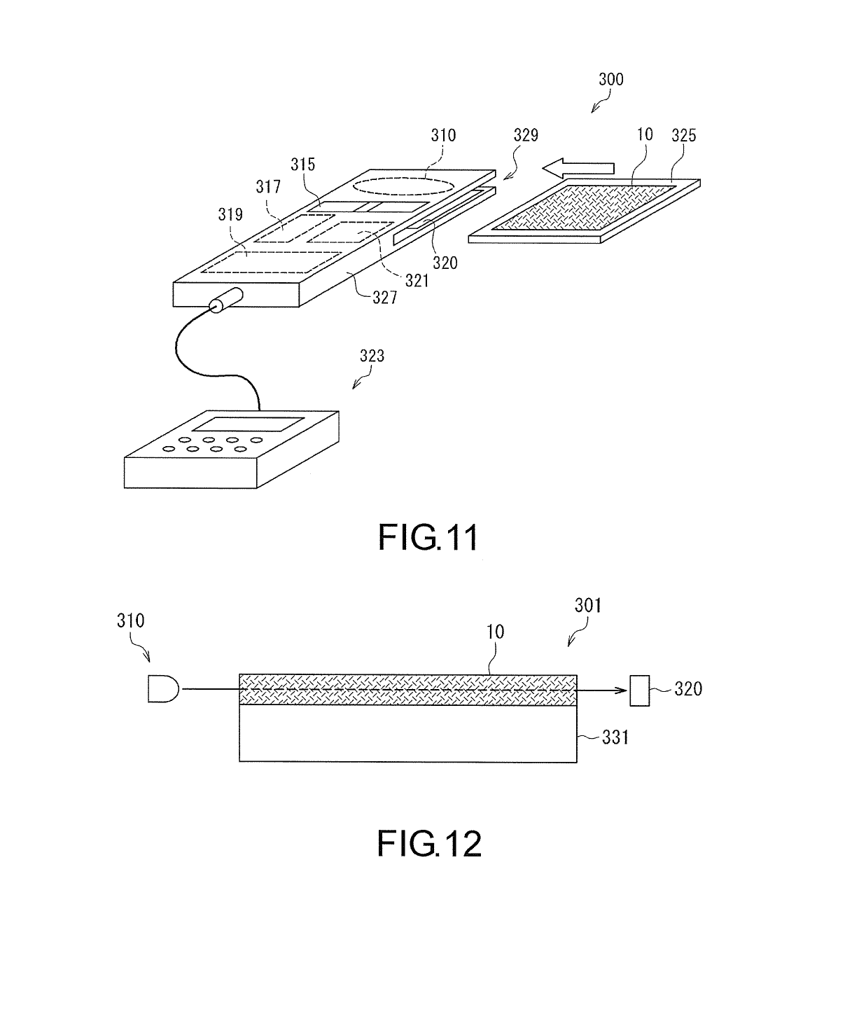

Next, a humidity sensor according to the second embodiment of the sensor element of the invention is described with reference to FIGS. 10 and 11. FIG. 10 illustrates a schematic constitution of a humidity sensor 300 according to the second embodiment of the invention. FIG. 11 shows an example of an appearance constitution of the sensor 300. The humidity sensor 300 includes a light source unit 310 emitting light, a light receiver 320 having an element (not shown) that converts light into current, and a nano-composite 10 interposed on an optical path between the light source unit 310 and the light receiver 320. In addition, the humidity sensor 300 includes a switch unit 315, an LED driver 317, a power supply 319 and an amplifier 321.

The light source unit 310 is configured to be able to emit two or more kinds of light having different wavelengths simultaneously or alternately. For example, the light source unit 310 includes a red LED lamp 311 that emits red light having a wavelength of 647 nm with high sensitivity to the humidity, and a green LED lamp 313 that emits green light having a wavelength of 570 nm with low sensitivity to the humidity. The light source unit 310 is connected to the switch unit 315. The switch unit 315 independently switches between ON/OFF of the red LED lamp 311 and the green LED lamp 313. The switch unit 315 is connected to the LED driver 317, and the driver 317 is connected to the power supply 319.

The light receiver 320 includes an element that converts light into current, such as a photodiode (not shown). The light receiver 320 is connected to the amplifier 321 so as to amplify a weak current obtained by conversion by the light receiver 320. The amplifier 321 is connected to an external measurement unit 323, which includes a generic multimeter, converts current to voltage and displays a magnitude thereof. It is also possible to include the measurement unit 323 in a component of the humidity sensor 300.

In the humidity sensor 300, the nano-composite 10 forms a “plasmon resonance generating unit” that generates LSPR. The nano-composite 10 is formed into, for example, a film shape with a thickness of about 1 to 2 mm, and has the same constitution as the above nano-composite 10 (also referring to FIGS. 1 to 4) except that the nano-composite 10 is held by a support frame 325 and detachably inserted between the light source unit 310 and the light receiver 320.

FIG. 11 illustrates a portable humidity sensor 300 having a switch unit 315, a driver 317, a power supply 319, a light source unit 310, a light receiver 320 and a amplifier 321 built in a plate-shaped housing 327. In the humidity sensor 300 of this embodiment, as shown in FIG. 11, the nano-composite 10 is used while being inserted, in a state of being fixed by the support frame 325, into an installation slit 329 disposed in the housing 327. Inside the installation slit 329, the light source unit 310 and the light receiver 320 are disposed opposite to each other. A spacing L (referring to FIG. 10) between the light source unit 310 and the light receiver 320 inside the installation slit 329 may be, for example, set to approximately 2 to 3 mm. In this way, since the nano-composite 10 is detachably configured, in a case where detection precision of the humidity is lowered due to degradation of the nano-composite 10, such as oxidation of the metal fine-particles 3, deformation or transformation of the solid framework 1a and so on, it will be easy to replace it with a new one.

In the humidity sensor 300, in a state that the power supply 319 is switched ON, and only the red LED lamp 311 is lighted by switching of the switch unit 315, it is possible to measure the humidity of an environment where the humidity sensor 300 is placed as a voltage value. The nano-composite 10 incorporated in the humidity sensor 300 changes the wavelength for generating LSPR depending on the ambient humidity. For this reason, if the red light with high sensitivity to the humidity is emitted from the red LED lamp 311, when the light is transmitted through the nano-composite 10, variation occurs in the wavelength under the influence of the humidity. This transmitted light is converted to a current by the light receiver 320, and may be measured by the measurement unit 323 as a variation in the voltage value.

In addition, in the humidity sensor 300, in a state that the power supply 319 is switched ON, and only the green LED lamp 313 having a wavelength with low sensitivity to the humidity is lighted by switching of the switch unit 315, a measurement of the voltage value is performed by the measurement unit 323. Based on a measured value at this moment, it is possible to perform drift compensation with respect to a light emitting side and a light receiving side respectively. Further, in the humidity sensor 300, in a state that the power supply 319 is switched OFF and both the red LED lamp 311 and the green LED lamp 313 are put out, the measurement of the voltage value is performed with the measurement unit 323. Based on a measured value at this moment, it is possible to perform drift compensation for an ambient light. In this way, with the humidity sensor 300, it is possible to detect the variation in the humidity with a high precision by performing compensation for the drift and the ambient light.

Next, variant examples of the humidity sensor according to the second embodiment are described with reference to FIGS. 12 to 14.

### First Variant Example

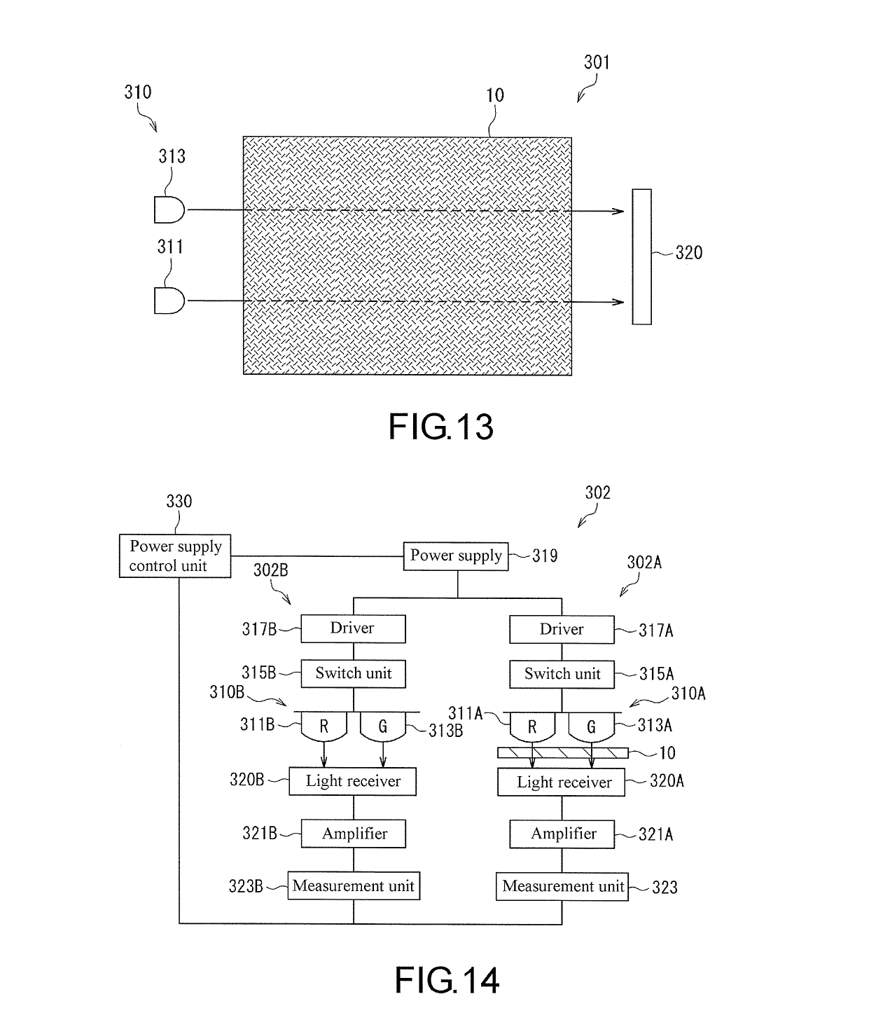

FIG. 12 is a side view showing a schematic constitution of a humidity sensor 301 according to the first variant example, and FIG. 13 is a plan view of the same. This humidity sensor 301 includes a light source unit 310 emitting light, a light receiver 320 having an element (not shown) converting light into a current, a nano-composite 10 interposed in the optical path between the light source unit 310 and the light receiver 320, and a substrate 331 supporting this nano-composite 10. The nano-composite 10 is laminated on the substrate 331.

In the humidity sensor 301, the configurations of the light source unit 310 and the light receiver 320 are the same as above. In addition, though not illustrated, the humidity sensor 301 includes a switch unit 315, a driver 317, a power supply 319 and an amplifier 321 (referring to FIG. 10). In addition, the amplifier 321 is connected to the external measurement unit 323. These configurations are also the same as above.

The material of the substrate 331 is not particularly limited as long as it is capable of supporting the nano-composite 10. For example, synthetic resins such as polyurethane resin, polystyrene resin, polytetrafluoroethylene resin and polyethylene resin, etc., glass, quartz, ceramics, silicon oxide, silicon nitride, metal and so on may be utilized. Among them, a dielectric material is preferred, and one with a high light transmission is more preferred. Moreover, the substrate 331 is not limited to a single layer, and may include two or more layers of different materials.

In the humidity sensor 301, the nano-composite 10 forms a “plasmon resonance generating unit” that generates LSPR, and is formed into a plate shape in appearance and interposed between the light source unit 310 and the light receiver 320. In the humidity sensor 301, the plate-shaped nano-composite 10 is disposed on the substrate 331 so light is emitted in a direction parallel to a principal surface with the largest area.

In the humidity sensor 301, in a state that the power supply 319 is switched ON, and only the red LED lamp 311 is lighted by switching of the switch unit 315, it is possible to measure the humidity of an environment where the humidity sensor 301 is placed as a voltage value. The nano-composite 10 incorporated in the humidity sensor 301 changes the wavelength for generating LSPR depending on the ambient humidity. For this reason, if the red light with high sensitivity to the humidity is emitted from the red LED lamp 311, as the light is transmitted through the nano-composite 10, variation occurs in the wavelength under the influence of the humidity. This transmitted light is converted into a current by the light receiver 320, and can be measured by the measurement unit 323 as a variation in the voltage value.

In addition, in the humidity sensor 300, in the same manner as the above, based on the measured value at the time of only lighting the green LED lamp 313, it is possible to perform drift compensation with respect to the light emitting side and the light receiving side respectively. Further, in the humidity sensor 300, based on the measured value at the time of putting out both the red LED lamp 311 and the green LED lamp 313, it is possible to perform compensation for the ambient light.

### Second Variant Example

FIG. 14 illustrates a schematic configuration of a humidity sensor 302 according to the second variant example. This humidity sensor 302 includes two systems each being a light emission/light reception/measurement system electrically connected to a common power supply 319.

A first system 302A includes a driver 317A, a switch unit 315A, a light source unit 310A, a light receiver 320A, an amplifier 321A and a measurement unit 323A. The light source unit 310A includes a red LED lamp 311A and a green LED lamp 313A. The light source unit 310A is connected to the switch unit 315A, and this switch unit 315A is connected to the driver 317A which is for LED. The driver 317A is connected to the common power supply 319. The switch unit 315A is configured so as to be able to independently switch between ON/OFF of the red LED lamp 311A and the green LED lamp 313A. The light receiver 320A disposed corresponding to the light source unit 310A is connected to the amplifier 321A, and this amplifier 321A is connected to the measurement unit 323A.

A second system 302B includes a driver 317B, a switch unit 315B, a light source unit 310B, a light receiver 320B, an amplifier 321B and a measurement unit 323B. The light source unit 310B includes a red LED lamp 311B and a green LED lamp 313B. The light source unit 310B is connected to the switch unit 315B, and this switch unit 315B is connected to the driver 317B which is for LED. The driver 317B is connected to the common power supply 319. The switch unit 315B is configured to be able to independently switch between ON/OFF of the red LED lamp 311B and the green LED lamp 313B. The light receiver 320B disposed corresponding to the light source unit 310B is connected to the amplifier 321B, and this amplifier 321B is connected to the measurement unit 323B.

While the nano-composite 10 is provided interposed in an optical path between the light source unit 310A and the light receiver 320A of the first system 302A, the nano-composite 10 is not provided between the light source unit 310B and the light receiver 320B of the second system 302B. That is to say, the second system 302B functions as a control for performing sensing of the humidity with good precision using the first system 302B.

The measurement units 323A and 323B are connected to a common power supply control unit 330, and respectively transmit a measured voltage to the power supply control unit 330 as a signal. The power supply control unit 330 is connected to the power supply 319 to control the power of the power supply 319. If the power supplied from the power supply 319 is unstable, intensity of light irradiated from the light emitting unit 310A of the first system 302A becomes unstable, and the light is received by the light receiver 320A, so a voltage value measured by the measurement unit 323A becomes unstable. Thus, accurate sensing will be difficult. In this variant example, by means of a voltage measured by the second system 302B not equipped with a nano-composite 10, variation in the supply power in the power supply 319 is detected, so the power supply control unit 330 controls the power of the power supply 319 to be stable. According to such feedback control, electricity supplied from the power supply 319 to the light source unit 310A of the first system 302A is stabilized to make high precision sensing possible. Moreover, a constitution is also possible in which, without the use of the amplifiers 321A and 321B as well as the measurement units 323A and 323B, the light receivers 320A and 320B respectively send a direct current to the power supply control unit 330, so as to control the power supply 319 based on the current.

A description in regard to the second embodiment has been given in the above, and other constitutions and effects of the present embodiment are the same as those of the first embodiment. Moreover, in the humidity sensor of the second embodiment, the measurement was performed by converting the light received by the light receiver into a current. However, as in the first embodiment, the intensity of light and the absorption spectrum may also serve as measurement objects.

### Third Embodiment

### Indirect Irradiation Sensor Element

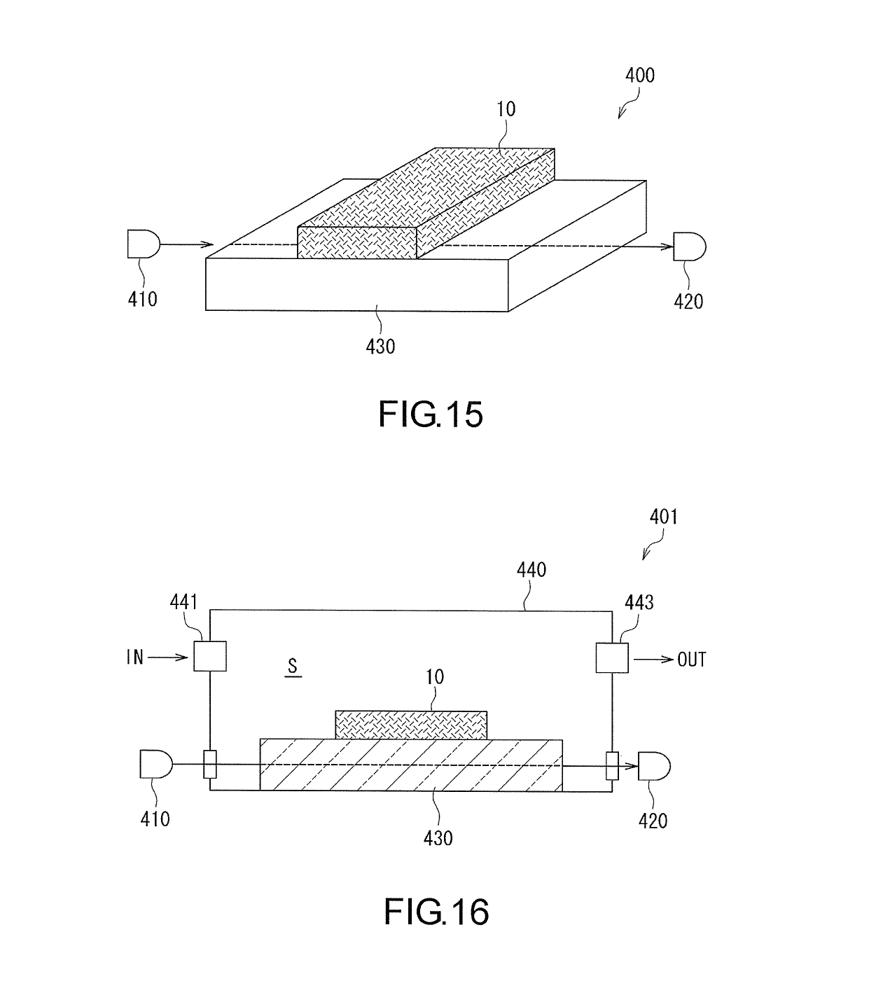

Next, a sensor element of the third embodiment of the invention is described with reference to FIGS. 15 and 16. FIG. 15 illustrates a schematic constitution of a sensor element 400 according to this embodiment. This sensor element 400 includes a light source unit 410 emitting light, a light receiver 420 receiving light, a light transmitting member 430 interposed between the light source unit 410 and the light receiver 420 to form an optical path, and the nano-composite 10 disposed in proximity to this light transmitting member 430. The sensor element 400 is applicable to applications such as a dew condensation sensor, a humidity sensor and so on.

In the sensor element 400, the nano-composite 10 is formed into a plate shape, and has the above composition (also referring to FIGS. 1 to 4).

The light source unit 410 and the light receiver 420 may be configured, e.g., in the same way as the light source 40A and the light receiver 40B in the dew condensation sensor 100 of the first embodiment, or the light source unit 310 and the light receiver 320 in the humidity sensor 300 of the second embodiment.

The light transmitting member 430 is formed into a plate shape having thickness, and includes a material that is light transmitting and capable of adjusting the refractive index. As such material, for example, glass, quartz, silicon and so on may be used. In the sensor element 400, the nano-composite 10 and the light transmitting member 430 constitute a “plasmon resonance generating unit” that generates LSPR. The nano-composite 10 is disposed in proximity to the light transmitting member 430, and preferably disposed in contact with the same.

In the sensor element 400, when light is emitted from the light source unit 410, an optical path is formed in the transparent light transmitting member 430. By means of the transmitted light that passes through the light transmitting member 430, LSPR occurs in the nano-composite 10 disposed in proximity to the light transmitting member 430. In this LSPR, the resonance wavelength varies depending on the variation in the dielectric constant, e.g., humidity variation, around the nano-composite 10. Thus, the transmitted light is received by the light receiver 420, and by measuring the absorption spectrum and the intensity of the light, the sensor element 400 is useful in applications such as a dew condensation sensor, a humidity sensor and so on.

FIG. 16 schematically illustrates a structure example of a humidity sensor 401 that used the sensor element 400 in FIG. 15. In the humidity sensor 401, the light transmitting member 430 and the nano-composite 10 are in a laminated state and accommodated in a housing 440. In the housing 440, an inlet 441 for introducing gas and an outlet 443 for discharging gas are formed. The gas introduced from the inlet 441 is configured to make the space S inside the housing 440 a flow channel, so that the moisture contained in the supplied gas is able to contact the nano-composite 10.

In addition, the light source unit 410 is disposed on one side of the housing 440, and the light receiver 420 is disposed on an opposite side. The light emitted from the light source unit 410 is incident from one side of the light transmitting member 430, transmits the optical path in the member 430, and is emitted from the opposite side and received by the light receiver 420. By means of the transmitted light that passes the light transmitting member 430, LSPR occurs in the nano-composite 10 disposed in proximity to the light transmitting member 430. Since the wavelength of LSPR varies depending on the humidity in the gas circulating in the space S, the humidity in the gas may be detected by measuring the absorption spectrum of the light received by the light receiver 420. In addition, in the sensor element 400, as in the second embodiment, the light may be converted into a current/voltage to be measured in the light receiver 420.

The other constitutions and effects of this embodiment are the same as the first embodiment. Moreover, in the sensor element 400, the nano-composite 10 may also be disposed as being divided into two or more regions in the travelling direction of the irradiation light. Further, in the light source unit 410, as in the second embodiment, a light source that generates two or more kinds of light may be disposed so as to perform a drift compensation or ambient light compensation.

### Fourth Embodiment

### FET Sensor Element

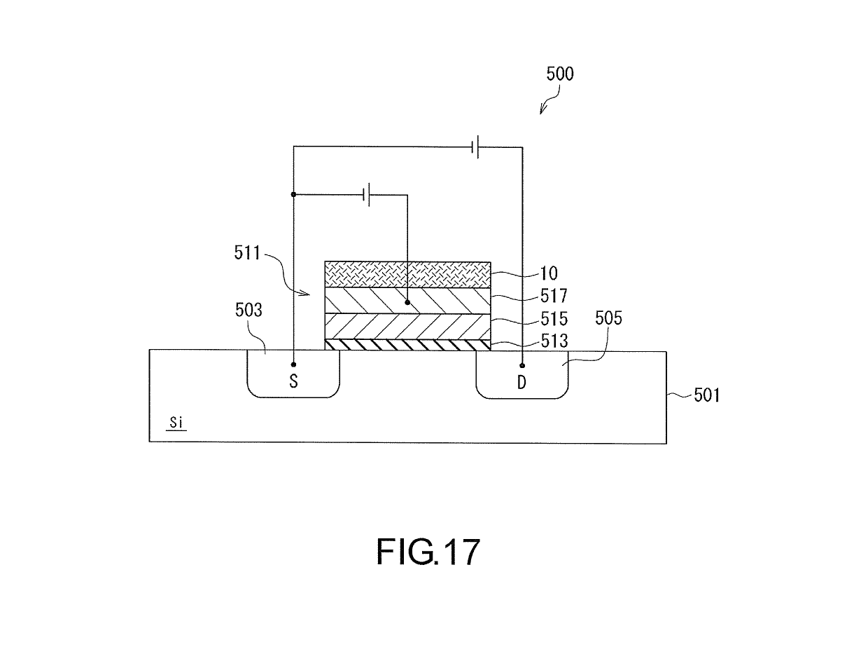

Next, the sensor element of the fourth embodiment of the invention is described with reference to FIGS. 17-19. FIG. 17 illustrates a schematic constitution of a sensor element 500 of the fourth embodiment of the invention. This sensor element 500 is a FET sensor element including a field effect transistor (FET). The sensor element 500 includes a Si substrate 501, a source region 503 and a drain region 505 having a polarity opposite to that of the Si substrate 501, a gate laminated body 511 formed on the Si substrate 501 between the source region 503 and the drain region 505, and a nano-composite 10 disposed on the gate laminated body 511.

As the FET, all possible structures are applicable, and for a typical example, a MOSFET structure such as an n-MOS (metal oxide semiconductor) FET or p-MOSFET or the like is preferred. In the sensor element 500, the source region 503 and the drain region 505 are p-doped when the Si substrate 501 is n-doped, and the source region 503 and the drain region 505 are n-doped when the Si substrate 501 is p-doped. A carrier (e.g., an electron or a hole) supplied from the source region 503 moves toward the drain region 505. By applying a voltage to a gate electrode layer 517 of the gate laminated body 511, flow of the carrier between the source 503 and drain 505 may be controlled.

The gate laminated body 511 is not particularly limited. Nevertheless, it may include a gate oxide film 513, a polysilicon layer 515 disposed on the gate oxide film 513 and a gate electrode layer 517 disposed on the polysilicon layer 515. The material of the gate electrode layer 517 is preferably metal, for example.

In the sensor element 500, the nano-composite 10 is formed into a plate shape, and has the same constitution as the above nano-composite 10 (also referring to FIGS. 1 to 4). The nano-composite 10 is laminated on the gate electrode 517.

In a case where the sensor element 500 is an n-channel MOSFET, in a state that no voltage is applied to the gate electrode layer 517, since a p-type semiconductor of a different nature is present sandwiched between the source region 503 and the drain region 505 that include n-type semiconductor, electrical insulation is provided between the source region 503 and the drain region 505. Meanwhile, when a voltage is applied to the gate electrode layer 517, electrons are drawn to a channel region underneath the gate laminated body 511, so an electron-rich state is provided between the source region 503 and the drain region 505, and a current flows between the source region 503 and the drain region 505. Here, the nano-composite 10 laminated on the gate laminated body 511 includes a large number of the metal fine-particles 3 in the matrix layer 1 having the voids 1b. For this reason, when the metal fine-particles 3 are in contact with or coupled with, e.g., a detected substance such as a chemical substance, a biomolecule, a water molecule and so on, electrical properties of the nano-composite 10 vary. For example, in the state that a voltage has been applied to the gate electrode layer 517, when the electrical properties of the nano-composite 10 vary, it has an impact on the current flowing between the source region 503 and the drain region 505 of the FET. By monitoring this variation in the current between source and drain, it is possible to sense the detected substance.

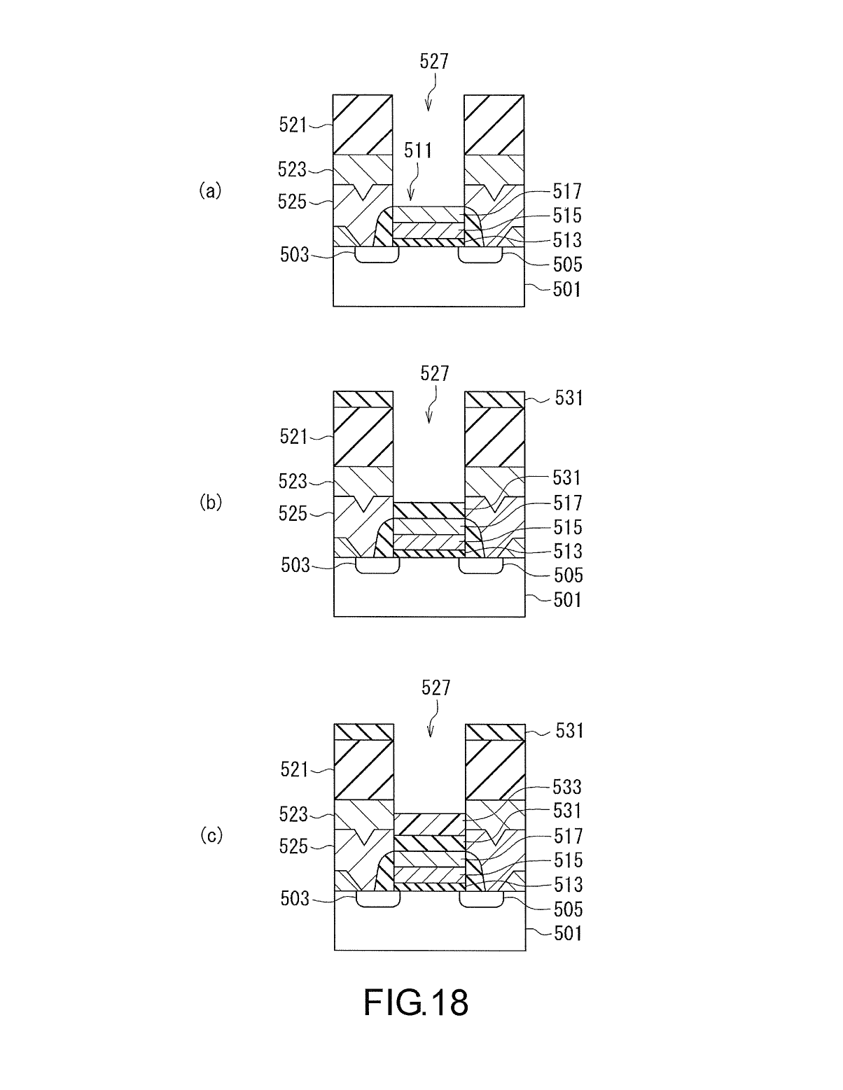

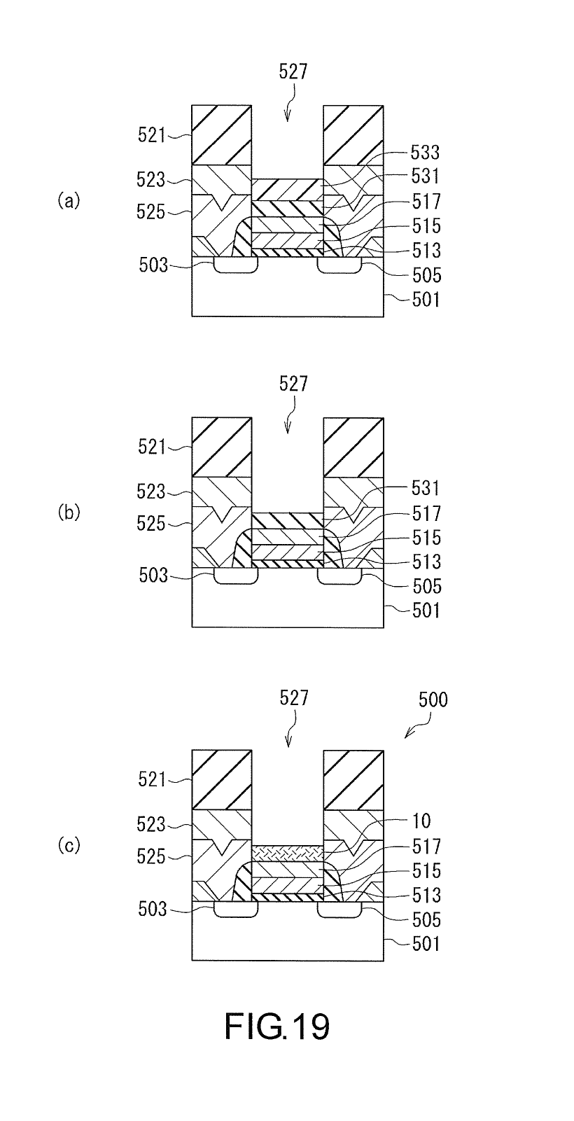

Next, a fabrication method of the sensor element 500 is described with reference to FIGS. 18 and 19. The sensor element 500 may be fabricated based on a generic FET. FIGS. 18 and 19 illustrate examples of a process of fabricating the sensor element 500 from the FET. Moreover, in the case of fabricating the sensor element 500, to reduce a thermal budget, it is preferred that the fabrication of the nano-composite 10 is performed by applying the above method (I).

First, in the completed FET, etching is performed to expose the gate electrode layer 517 of the gate laminated body 511. Specifically, as shown in FIG. 18(a), by sequentially etching a passivation film 521 that covers the gate laminated body 511, and metal layers 523 and 525 for electrode, an opening 527 is formed. This etching may be performed by a known method by utilizing photolithographic technique.

Next, as shown in FIG. 18(b), a coating liquid containing a slurry containing an aluminum oxyhydroxide or an alumina hydrate for forming the solid framework 1a is coated and dried to form a coated film 531. This step may be implemented in the same manner as the steps Ia) to Ic) of the above method (I).

Next, as shown in FIG. 18(c), a photoresist material is selectively pattern-coated in the opening 527 to form a photoresist layer 533.

Next, as shown in FIG. 19(a), the coated film 531 formed outside the opening 527 is removed by an etching treatment, which may be performed by, e.g., dry etching.

Next, as shown in FIG. 19(b), the photoresist layer 533 inside the opening 527 is removed. Finally, as shown in FIG. 19(c), a heating treatment is performed to form the nano-composite 10. Conditions of the heating treatment may be implemented in the same manner as in the step Id) of the above method (I). In the above way, the sensor element 500, which is a FET sensor, may be fabricated from a MOSFET having a generic constitution.

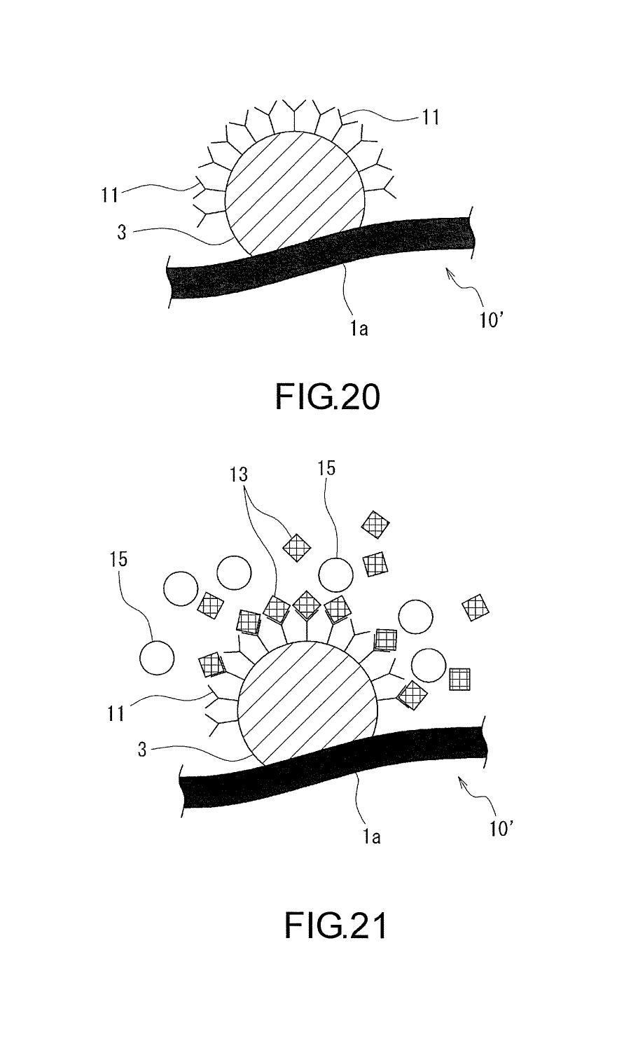

In addition, in the sensor element 500 of this embodiment, though the nano-composite 10 having the above constitution (also referring to FIGS. 1 to 4) may be used, in a preferred embodiment, for example, as shown in FIG. 20 in a magnified view, the nano-composite 10′ having a binding species 11 immobilized on the surface of the metal fine-particles 3 may be used. In the nano-composite 10′, the binding species 11 may be defined as a substance having: a functional group X that can be bonded to the metal fine-particles 3, and a functional group Y interacting with a specific substance such as a detection object molecule. The binding species 11 is not limited to be a single molecule, and may include a substance such as a composite one consisting of, e.g., two or more constituents. The binding species 11 is immobilized on the surface of the metal fine-particles 3 through bonding between the functional group X and the metal fine-particles 3. In this case, the bonding between the functional group X and the metal fine-particles 3 refers to, e.g., chemical bonding, or physical bonding such as adsorption. In addition, the interaction between the functional group Y and the specific substance refers to, besides chemical bonding and physical bonding such as adsorption, a partial or overall change (modification or removal, etc.) of the group Y.

The functional group X of the binding species 11 is a function group that may be immobilized on the surface of the metal fine-particles 3 possibly by chemical bonding or by adsorption. Examples of such functional group X include: monovalent groups, such as —SH, —NH₂, —NH₃X (X is a halogen atom), —COOH, —Si(OCH₃)₃, —Si(OC₂H₅)₃, —SiCl₃ and —SCOCH₃; and divalent groups, such as —S₂— and —S₄—. Among these groups, the functional groups containing a sulfur atom, such as the mercapto group, the sulfide group and the disulfide group, are preferred.

In addition, the functional group Y of the binding species 11 is, e.g., a substituent that may be bonded to an inorganic compound such as a metal or a metal oxide, or an organic compound such as DNA or protein, or a leaving group that may leave due to, e.g., an acid or alkali. Examples of the functional group Y capable of performing such interaction include: —SH, —NH₂, —NR₃X (R is a hydrogen atom or C₁₋₆ alkyl, and X is a halogen atom), —COOR (R is a hydrogen atom or C₁₋₆ alkyl), —Si(OR)₃ (R is C₁₋₆ alkyl), —SiX₃ (X is a halogen atom), —SCOR (R is C₁₋₆ alkyl), —OH, —CONH₂, —N₃, —CR═CHR′ (R and R′ are independently a hydrogen atom or C₁₋₆ alkyl), —C≡CR (R is a hydrogen atom or C₁₋₆ alkyl), —PO(OH)₂, —COR (R is C₁₋₆ alkyl), imidazolyl group, hydroquinolyl group, —SO₃⁻X (X is an alkali metal), N-hydroxysuccinimide group (—NHS), biotin group (-Biotin), and —SO₂CH₂CH₂X (X is a halogen atom, —OSO₂CH₃, —OSO₂C₆H₄CH₃, —OCOCH₃, —SO₃⁻, or pyridium).

Specific examples of the binding species 11 include HS—(CH₂)ₙ—OH (n=11 or 16), HS—(CH₂)ₙ—COOH (n=10, 11 or 15), HS—(CH₂)ₙ—COO—NHS (n=10, 11 or 15), HS—(CH₂)ₙ—NH₂.HCl (n=10, 11 or 16), HS—(CH₂)₁₁—NHCO-Biotin, HS—(CH₂)₁₁—N(CH₃)₃⁺Cl⁻, HS—(CH₂)ₙ—SO₃⁻Na⁺(n=10, 11 or 16), HS—(CH₂)₁₁—PO(OH)₂, HS—(CH₂)₁₀—CH(OH)—CH₃, HS—(CH₂)₁₀—COCH₃, HS—(CH₂)ₙ—N₃ (n=10, 11, 12, 16 or 17), HS—(CH₂)ₙ—CH═CH₂ (n=9 or 15), HS—(CH₂)₄—C═CH, HS—(CH₂)ₙ—CONH₂ (n=10 or 15), HS—(CH₂)₁₁—(OCH₂CH₂)ₙ—OCH₂—CONH₂ (n=3 or 6), HO—(CH₂)₁₁—S—S—(CH₂)₁₁—OH, CH₃—CO—S—(CH₂)₁₁—(OCH₂CH₂)ₙ—OH (n=3 or 6), and so on.

Other examples of the binding species 11 include heterocyclic compounds having an amino group or a mercapto group, such as 2-amino-1,3,5-triazine-4,6-dithiol, 3-amino-1,2,4-triazole-5-thiol, 2-amino-5-trifluoromethyl-1,3,4-thiadiazole, 5-amino-2-mercaptobenzimidazole, 6-amino-2-mercaptobenzothiazole, 4-amino-6-mercaptopyrazolo[3,4-d]pyrimidine, 2-amino-4-methoxybenzothiazole, 2-amino-4-phenyl-5-tetradecylthiazole, 2-amino-5-phenyl-1,3,4-thiadiazole, 2-amino-4-phenylthiazole, 4-amino-5-phenyl-4H-1,2,4-triazole-3-thiol, 2-amino-6-(methylsulfonyl)benzothiazole, 2-amino-4-methylthiazole, 2-amino-5-(methylthio)-1,3,4-thiadiazole, 3-amino-5-methylthio-1H-1,2,4-thiazole, 6-amino-1-methyluracil, 3-amino-5-nitrobenzisothiazole, 2-amino-1,3,4-thiadiazole, 5-amino-1,3,4-thiadiazole-2-thiol, 2-aminothiazole, 2-amino-4-thiazoleacetic acid, 2-amino-2-thiazoline, 2-amino-6-thiocyanate benzothiazole, DL-α-amino-2-thiophene acetic acid, 4-amino-6-hydroxy-2-mercaptopyrimidine, 2-amino-6-purinethiol, 4-amino-5-(4-pyridyl)-4H-1,2,4-triazole-3-thiol, N⁴-(2-amino-4-pyrimidinyl)sulfanilamide, 3-aminorhodanine, 5-amino-3-methylisothiazole, 2-amino-α-(methoxyimino)-4-thiazoleacetic acid, thioguanine, 5-aminotetrazole, 3-amino-1,2,4-triazine, 3-amino-1,2,4-triazole, 4-amino-4H-1,2,4-triazole, 2-aminopurine, aminopyrazine, 3-amino-2-pyrazinecarboxylic acid, 3-aminopyrazole, 3-aminopyrazole-4-carbonitrile, 3-amino-4-pyrazolecarboxylic acid, 4-aminopyrazolo[3,4-d]pyrimidine, 2-aminopyridine, 3-aminopyridine, 4-aminopyridine, 5-amino-2-pyridinecarbonitrile, 2-amino-3-pyridinecarboxaldehyde, 2-amino-5-(4-pyridinyl)-1,3,4-thiadiazole, 2-aminopyrimidine, 4-aminopyrimidine and 4-amino-5-pyrimidinecarbonitrile, etc.; silane coupling agents having an amino group or a mercapto group, such as 3-aminopropyltriethoxysilane, 3-aminopropyltrimethoxysilane, N-2-(aminoethyl)-3-aminopropyltrimethoxysilane, N-2-(aminoethyl)-3-aminopropylmethyldimethoxysilane, 3-triethoxysilyl-N-(1,3-dimethylbutylidene)propylamine, N-phenyl-3-aminopropyltrimethoxysilane, 3-mercaptopropyltriethoxysilane, 3-mercaptopropyltrimethoxysilane, N-2-(mercaptoethyl)-3-mercaptopropyltrimethoxysilane, N-2-(mercaptoethyl)-3-mercaptopropylmethyldimethoxysilane, 3-triethoxysilyl-N-(1,3-dimethylbutylidene)propylmercapto and N-phenyl-3-mercaptopropyltrimethoxysilane, etc.; and so on. Moreover, these species may be used alone or in combination of two or more without particular limitation.

In addition, the molecular backbone of the binding species 11 may have a linear, branched or cyclic chemical structure including, between the functional groups X and Y, atoms selected from the group consisting of carbon atom, oxygen atom and nitrogen atom. The chemical structure may have a linear portion having 2 to 20, preferably 2 to 15, and more preferably 2 to 10 carbon atoms, and may be designed using a single molecular species or two or more molecular species. In an example of suitably applied embodiments where, for example, a detection-object molecule or the like is to be effectively detected, it is preferred that the thickness of the molecular mono-film (or molecular monolayer) formed by the binding species 11 is in the range of about 1.3 to 3 nm. In view of this, a binding species 11 having a C₁₁-C₂₀ alkane chain as a molecular skeleton is preferred. In this case, for the long alkane chain immobilized on the surface of the metal fine-particle 3 via the functional group X extends almost vertically from the surface to form a molecular mono-film (or molecular monolayer), the functional group Y suffuses the surface of the molecular mono-film (or molecular monolayer). Well-known thiol compounds useful as reagents for forming self-assembly mono-films (SAM) may be suitably used as such binding species 11.

Here, a fabrication method of the nano-composite 10′ is simply described. The fabrication of the nano-composite 10′ may be performed by adding the following steps after fabricating the nano-composite 10 by the above method (I) or method (II).

Ie) immobilizing the binding species 11 on the surface of the metal fine-particles 3 after the step Id.

IIe) immobilizing the binding species 11 on the surface of the metal fine-particles 3 after the step IId.

The steps Ia) to Id) in the method (I) and the steps IIa) to IId) in the method (II) are the same as those mentioned in the descriptions for the above methods (I) and (II), so the descriptions thereof are omitted. The step Ie) or Ie) is a step of immobilizing a binding species to obtain the nano-composite 10′ by adding the binding species 11 to the metal fine-particles 3 of the nano-composite 10, and may be performed as follows.

Step of Immobilizing Binding Species:

In the step of immobilizing the binding species 11, the binding species 11 is immobilized to the surfaces of the exposed portions of the metal fine-particles 3. This step may be performed by making the binding species 11 in contact with the surfaces of the exposed portions of the metal fine-particles 3. For example, it is preferred to perform a surface treatment to the metal fine-particles 3 using a treatment liquid obtained by dissolving the binding species 11 in a solvent. The solvent for dissolving the binding species 11 may be, but not limited to, water, a C₁₋₈ hydrocarbon alcohol such as methanol, ethanol, propanol, isopropanol, butanol, t-butanol, pentanol, hexanol, heptanol or octanol, etc., a C₃₋₆ hydrocarbon ketone such as acetone, propanone, methyl ethyl ketone, pentanone, hexanon, methyl isobutyl ketone or cyclohexanone, etc., a C₄₋₁₂ hydrocarbon ether such as diethyl ether, ethyleneglycol dimethyl ether, diethylene glycol dimethyl ether, diethylene glycol diethyl ether, diethylene glycol dibutyl ether or tetrahydrofuran, etc., a C₃₋₇ hydrocarbon ester such as methyl acetate, ethyl acetate, propyl acetate, butyl acetate, γ-butyrolactone or diethyl malonate, etc., a C₃₋₆ amide such as dimethylformamide, dimethylacetamide, tetramethylurea or hexamethylphosphoric triamide, etc., a C₂ sulfoxide compound such as dimethyl sulfoxide, etc., a C₁₋₆ halogen-containing compound such as chloromethane, bromomethane, dichloromethane, chlorofolin, carbon tetrachloride, dichloroethane, 1,2-dichloroethane, 1,4-dichlorobutane, trichloroethane, chlorobenzene or o-dichlorobenzene, etc., or a C₄₋₈ hydrocarbon such as butane, hexane, heptane, octane, benzene, toluene or xylene, etc.

The concentration of the binding species 11 in the treatment liquid is preferably, e.g., 0.0001 to 1M (mol/L). A low concentration is advantageous in view of less attachment of excess binding species 11 to the surface of the metal fine-particles 3. If a sufficient film formation effect generated by the binding species 11 is desired, the concentration is more preferably 0.005 to 0.05 M.

In a case where the surface of the metal fine-particles 3 is treated by the above treatment liquid, the treating method is not particularly limited as long as the treatment liquid is in contact with the surfaces of the exposed portions of the metal fine-particles 3. Nevertheless, an even contact is preferred. For example, the nano-composite 10 with the metal fine-particles 3 may be immersed in the treatment liquid, or the treatment liquid may be sprayed onto the exposed portions of the metal fine-particles 3 in the nano-composite 10 using a spray or the like. In addition, the temperature of the treatment liquid at this moment is not particularly limited, and is, e.g., −20° C. to 50° C. In addition, in a case of using an immersion method for the surface treatment, the immersion time is preferably 1 minute to 24 hours.

After the surface treatment is completed, it is preferred to perform a cleaning step to dissolve and remove the excess binding species 11 attached to the surface of the metal fine-particles 3 using an organic solvent. The organic solvent used therein may be one capable of dissolving the binding species 11, and examples thereof include the solvents that are used to dissolve the binding species 11 in the precedent step.

In the cleaning step, the method of cleaning the surface of the fine-particles 3 using an organic solvent is not limited. For example, the method may be achieved by immersing the metal fine-particles 3 in the organic solvent, or by spraying the organic solvent onto the surface of the metal fine-particles 3 using a spray or the like and then washing the organic solvent away. In this cleaning step, although the excess binding species 11 attached to the surface of the metal fine-particles 3 is dissolved and removed, removal of all the binding species 11 must not be done. Advantageously, the binding species 11 is cleaned and removed so that a film of the binding species 11 on the surface of the metal fine-particles 3 is approximately as thick as a monomolecular film. This method includes a step of cleaning with water before the aforementioned cleaning step, the aforementioned cleaning step, and then another step of cleaning with water. The temperature of the organic solvent in the above cleaning step is preferably 0 to 100° C. and more preferably 5 to 50° C. The cleaning time is preferably in the range of 1 to 1000 seconds and more preferably 3 to 600 seconds. The amount of the used organic solvent is preferably 1 to 500 L, and more preferably 200 to 400 L, per 1 m² surface area of the nano-composite 10.

In addition, if necessary, it is preferred to remove the binding species 11 attached to the surface of the solid framework 1a using an aqueous alkali solution. The concentration of the aqueous alkali solution used at this moment is preferably 10 to 500 mM (mmol/L), and the temperature of the same is preferably 0 to 50° C. For example, in a case where the solid framework 1a is immersed in an aqueous alkali solution, the immersion time is preferably set to 5 seconds to 3 minutes.

The sensor element 500 provide with the nano-composite 10′ having the above structure may serve as, e.g., an affinity sensor. FIG. 21 conceptually illustrates an application of the nano-composite 10′ to an affinity sensor. First, the nano-composite 10′ having a structure in which the binding species 11 (ligand) is bonded to the exposed portion (the part exposed in the voids 1b) of the metal fine-particles 3 immobilized to the solid framework 1a is prepared. A sample containing an analyte 13 and a non-detection object substance 15 are then made to contact the nano-composite 10′ in which the binding species 11 is bonded to the metal fine-particles 3. Because the binding species 11 has a specific bindability to the analyte 13, specific bonding between the analyte 13 and the binding species 11 occurs. The non-detection object substance 15 having no specific bindability to the binding species 11 is not bonded to the binding species 11. As compared with the nano-composite 10′ in which the analyte 13 is not bonded but only the binding species 11 is bonded, for the nano-composite 10′ in which the analyte 13 is bonded via the binding species 11, the electrical properties vary. As a result, in a state that a voltage has been applied to the gate electrode layer 517 of the sensor element 500, the current flowing between the source 503 and the drain 505 of the FET is impacted. By monitoring this variation in the current between source and drain, the analyte 13 as the detected substance may be detected with high sensitivity. In this way, the sensor element 500 provided with nano-composite 10′ need not to use any labeling substance, and are applicable in various fields such as bio-sensors, gas sensors, chemical sensors and so on, as sensing means having a simple configuration.

Moreover, though not illustrated here, in this embodiment, in order to heat the nano-composites 10 and 10′ of the sensor element 500 to enhance the detection efficiency, a heating means such as a heater may be arranged in proximity to the nano-composites 10 and 10′.

Although the embodiments of the invention have been shown and described in the above, the invention is not limited to the above embodiments so that various variants are possible.

### DESCRIPTION OF REFERENCE CHARACTERS

1: Matrix layer; la: Solid framework; 1b: Void; 3: Metal fine-particle; 10: Nano-composite; 20: Light reflecting member; 21: Light transmitting layer; 23: Metal layer; 30: Protection layer; 40: Light source/light receiver; 50: Spectroscope (or photo-detector); 60: Controller; 70: Display unit; 80: Temperature measurement device; 90: Temperature control device; 100: Dew condensation sensor; 101: Housing; 200: Dew point meter

1. A sensor element, comprising:
a metal fine-particle dispersed composite; and
a detection unit detecting variation in an optical signal or an electrical signal generated by interaction between a detected substance and the metal fine-particle dispersed composite,
wherein the metal fine-particle dispersed composite comprises a matrix layer comprising a solid framework and voids formed by the solid framework, and metal fine-particles immobilized to the solid framework, and has constitutions a) to d):
a) the solid framework containing an aluminum oxyhydroxide or an alumina hydrate and forming a three-dimensional network structure;
b) the metal fine-particles having a mean particle diameter in a range of 3 to 100 nm, with a proportion of 60% or more having particle diameters in a range of 1 to 100 nm;
c) the metal fine-particles being formed in the matrix layer by heat-reducing a metal ion and being present in a manner that the metal fine-particles are not in contact with one another and neighboring metal fine-particles are apart from each other by a distance equal to or larger than the particle diameter of a larger one of the neighboring metal fine-particles; and
d) the metal fine-particles being dispersed three-dimensionally in the matrix layer, wherein each metal fine-particle has a portion exposed in the voids of the matrix layer.

2. (canceled)

3. The sensor element of claim 1, wherein a void ratio of the metal fine-particle dispersed composite is in a range of 15 to 95%.

4. The sensor element of claim 1, wherein a volume fraction of the metal fine-particles in the metal fine-particle dispersed composite is in a range of 0.05 to 30%.

5. The sensor element of claim 1, wherein the metal fine-particles comprise Au, Ag or Cu.

6. The sensor element of claim 1, wherein the metal fine-particles generate a localized surface plasmon resonance when interacting with light of a wavelength of 380 nm or more.

7. A dew condensation sensor, comprising:
a metal fine-particle dispersed composite;
a light reflecting member disposed on one side of the metal fine-particle dispersed composite;
a light source irradiating the metal fine-particle dispersed composite with light;
a light receiver receiving light reflected by a surface of the metal fine-particle dispersed composite and the light reflecting member; and
a spectroscopic device measuring an absorption spectrum of the reflected light or a photo-detector measuring an intensity of the reflected light,
wherein the metal fine-particle dispersed composite is characterized by comprising a matrix layer comprising a solid framework and voids formed by the solid framework, and metal fine-particles immobilized to the solid framework, and has constitutions a) to d):
a) the solid framework containing an aluminum oxyhydroxide or an alumina hydrate and forming a three-dimensional network structure;
b) the metal fine-particles having a mean particle diameter in a range of 3 to 100 nm, with a proportion of 60% or more having particle diameters in a range of 1 to 100 nm;
c) the metal fine-particles being formed in the matrix layer by heat-reducing a metal ion and being present in a manner that the metal fine-particles are not in contact with one another and neighboring metal fine-particles are apart from each other by a distance equal to or larger than the particle diameter of a larger one of the neighboring metal fine-particles; and
d) the metal fine-particles being dispersed three-dimensionally in the matrix layer, wherein each metal fine-particle has a portion exposed in the voids of the matrix layer.

8. The dew condensation sensor of claim 7, wherein the metal fine-particle dispersed composite comprises:
a first surface receiving light emitted from a light source; and
a second surface formed opposite to the first surface; and
the light reflecting member is disposed in contact with the second surface.

9. The dew condensation sensor of claim 7, wherein the light reflective member comprises:
a light transmitting layer; and
a metal layer laminated on the light transmitting layer.

10. The dew condensation sensor of claim 9, wherein the light reflecting member further comprises a protection layer covering the metal layer.

11. The dew condensation sensor of claim 10, wherein the protection layer comprises a Ni—Cr alloy.

12. A dew point measurement device, comprising:
the dew condensation sensor of claim 7;
a temperature measurement device measuring a temperature of the metal fine-particle dispersed composite; and
a temperature control device performing a temperature adjustment of the metal fine-particle dispersed composite.

13. A dew condensation detecting method that detects an occurrence of dew condensation based on a variation in an absorption spectrum, an absorption intensity or a reflected-light intensity of local surface plasmon resonance, by means of the dew condensation sensor of claim 7.

14. A sensor element, comprising:
a light source emitting light;
a light receiver receiving light; and
a metal fine-particle dispersed composite interposed in an optical path between the light source and the light receiver,
wherein the metal fine-particle dispersed composite comprises a matrix layer comprising a solid framework and voids formed by the solid framework, and metal fine-particles immobilized to the solid framework, and has constitutions a) to d):
a) the solid framework containing an aluminum oxyhydroxide or an alumina hydrate and forming a three-dimensional network structure;
b) the metal fine-particles having a mean particle diameter in a range of 3 to 100 nm, with a proportion of 60% or more having particle diameters in a range of 1 to 100 nm;
c) the metal fine-particles being formed in the matrix layer by heat-reducing a metal ion and being present in a manner that the metal fine-particles are not in contact with one another and neighboring metal fine-particles are apart from each other by a distance equal to or larger than the particle diameter of a larger one of the neighboring metal fine-particles; and
d) the metal fine-particles being dispersed three-dimensionally in the matrix layer, wherein each metal fine-particle has a portion exposed in the voids of the matrix layer.

15. A sensor element, comprising:
a light source emitting light;
a light receiver receiving light;
a light transmitting member forming an optical path between the light source and the light receiver; and
a metal fine-particle dispersed composite disposed in proximity to the light transmitting member,
wherein the metal fine-particle dispersed composite comprises a matrix layer comprising a solid framework and voids formed by the solid framework, and metal fine-particles immobilized to the solid framework, and has constitutions a) to d):
a) the solid framework containing an aluminum oxyhydroxide or an alumina hydrate and forming a three-dimensional network structure;
b) the metal fine-particles having a mean particle diameter in a range of 3 to 100 nm, with a proportion of 60% or more having particle diameters in a range of 1 to 100 nm;
c) the metal fine-particles being formed in the matrix layer by heat-reducing a metal ion and being present in a manner that the metal fine-particles are not in contact with one another and neighboring metal fine-particles are apart from each other by a distance equal to or larger than the particle diameter of a larger one of the neighboring metal fine-particles; and
d) the metal fine-particles being dispersed three-dimensionally in the matrix layer, wherein each metal fine-particle has a portion exposed in the voids of the matrix layer.

16. A humidity sensor comprising the sensor element of claim 14 to detect variation in humidity.

17. The humidity sensor of claim 16, wherein the light source irradiates the metal fine-particle dispersed composite with light of at least two kinds of wavelengths including a wavelength for humidity measurement and a wavelength for correction.

18. A field effect transistor sensor element, comprising:
a substrate;
a source region and a drain region having a polarity opposite to a polarity of the substrate;
a gate laminated body formed on the substrate between the source region and the drain region; and
a metal fine-particle dispersed composite disposed on the gate laminated body,
wherein the metal fine-particle dispersed composite comprises a matrix layer comprising a solid framework and voids formed by the solid framework, and metal fine-particles immobilized to the solid framework, and has constitutions a) to d):
a) the solid framework containing an aluminum oxyhydroxide or an alumina hydrate and forming a three-dimensional network structure;
b) the metal fine-particles having a mean particle diameter in a range of 3 to 100 nm, with a proportion of 60% or more having particle diameters in a range of 1 to 100 nm;
c) the metal fine-particles being formed in the matrix layer by heat-reducing a metal ion and being present in a manner that the metal fine-particles are not in contact with one another and neighboring metal fine-particles are apart from each other by a distance equal to or larger than the particle diameter of a larger one of the neighboring metal fine-particles; and
d) the metal fine-particles being dispersed three-dimensionally in the matrix layer, wherein each metal fine-particle has a portion exposed in the voids of the matrix layer.

19. A humidity sensor comprising the sensor element of claim 15 to detect variation in humidity.

20. The humidity sensor of claim 19, wherein the light source irradiates the metal fine-particle dispersed composite with light of at least two kinds of wavelengths including a wavelength for humidity measurement and a wavelength for correction.
